(19) United States
(12) Patent Application Publication
(10) Pub. No.: US 2005/0264461 A1
(43) Pub. Date: Dec. 1, 2005

(54) Mobile antenna mounted on a vehicle body

(75) Inventors: Yuji Sugimoto, Kariya-shi (JP); Toshihiro Hattori, Okazaki-shi (JP); Koji Numata, Toyokawa-shi (JP); Masaaki Hisada, Oobu-shi (JP); Toru Yamazaki, Chita-shi (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); NIPPON SOKEN, INC., Nishio-city (JP)

(21) Appl. No.: 11/139,038

(22) Filed: May 27, 2005

(30) Foreign Application Priority Data
May 28, 2004 (JP) 2004-159255
Mar. 29, 2005 (JP) 2005-094901

(51) Int. Cl. H01Q 1/32

(52) U.S. Cl. 343/713

(57) ABSTRACT

In a mobile antenna, an electrically conductive antenna element has a first portion with one end and the other end extending therefrom. The one end of the first portion is arranged at least adjacent to any one of a roof portion, a pillar portion, and a corner portion of a body of a vehicle. The one end of the first portion is electrically connected to a feeding point. The other end of the first portion is arranged along a surface of the window such that polarized surfaces formed by the antenna element are non-orthogonal to each polarized surface of each of a vertically polarized wave and a horizontally polarized wave in radio waves.

### BACKGROUND OF THE INVENTION

### CROSS REFERENCE TO RELATED APPLICATIONS

This application is based on Japanese Patent Application 2004-159255 filed on May 28, 2004 and Japanese Patent Application 2005-94901 filed on Mar. 29, 2005. This application claims the benefit of priority therefrom, so that the descriptions of which are all incorporated herein by reference.

### FIELD OF THE INVENTION

The present invention relates to a mobile antenna mounted on the body of a vehicle and configured to receive radio waves within, for example, television broadcast bands.

### DESCRIPTION OF THE RELATED ART

Mobile antennas for receiving radio waves within television broadcast bands include rod antennas, film antennas, and the like. In recent years, film antennas are becoming mainstream because they have hard deformation characteristic and low impact on the appearance of the vehicle body without causing wind noises.

These types of mobile antennas require to have a wideband characteristic capable of receiving a plurality of channels within the VHF band and the UHF band, and a nondirectional characteristic for receiving radio waves in all directions independently of any direction of travel.

An example of these types of mobile antennas is disclosed in Japanese Unexamined Patent Publication No. 2004-72419.

Assuming that a mobile antenna disclosed in the Patent Publication is mounted at the middle portion of the top edge of a front windshield of a vehicle, if radio waves are transmitted from the front side of the vehicle, the mobile antenna can efficiently receive the radio waves transmitted from the front side of the vehicle.

In contrast, in this assumption, if radio waves are transmitted from the rear side of the vehicle, because the radio waves are shielded by the vehicle body, the mobile antenna may not efficiently receive the radio waves transmitted from the rear side of the vehicle. This may cause the receiving efficiency of the mobile antenna with respect to the radio waves transmitted from the rear side of the vehicle to decrease.

In order to solve the problem, it is to be considered that the mobile antennas disclosed in FIG. 13 of the Patent Publication are mounted to be spaced along the top edge of a front windshield of a vehicle to constitute a diversity system. Specifically, the diversity system is configured such that output signals from the mobile antennas based on the received radio waves thereby are combined to give a single signal. It may be difficult for the diversity system, however, to improve the receiving efficiency of each of the mobile antennas with respect to radio waves transmitted from the rear side of a vehicle.

### SUMMARY OF THE INVENTION

The present invention has been made on the background above so that at least one preferable embodiment of the present invention provides a mobile antenna mounted on a body of a vehicle, which is capable of stably receiving radio waves independently of any direction of the vehicle's travel and/or any direction from which the radio waves are transmitted.

According to one aspect of the present invention, there is provided a mobile antenna mounted on an electrically conductive body of a vehicle, in which the body of the vehicle has a roof portion, a pillar portion, and a corner portion at which the roof portion and the pillar portion meet, the roof portion, the pillar portion, and the corner portion supporting at least corner portion of a window of the vehicle. The mobile antenna comprises an electrically conductive antenna element having a first portion with one end and the other end extending therefrom. The one end of the first portion is arranged at least adjacent to any one of the roof portion, the pillar portion, and the corner portion. The one end of the first portion is electrically connected to a feeding point. The other end of the first portion is arranged along a surface of the window such that polarized surfaces formed by the antenna element are non-orthogonal to each polarized surface of each of a vertically polarized wave and a horizontally polarized wave in radio waves.

According to another aspect of the present invention, there is provided a mobile antenna system mounted on an electrically conductive body of a vehicle, in which the body of the vehicle has a roof portion, a pillar portion, and a corner portion at which the roof portion and the pillar portion meet, the roof portion, the pillar portion, and the corner portion supporting at least corner portion of a first window of the vehicle, and the roof portion supporting a second window of the vehicle. The mobile antenna system comprises a first mobile antenna including a first electrically conductive antenna element. The first antenna element has a first portion with one end and the other end extending therefrom. The one end of the first portion is arranged at least adjacent to any one of the roof portion, the pillar portion, and the corner portion. The one end of the first portion is electrically connected to a first feeding point. The other end of the first portion is arranged along a surface of the first window such that polarized surfaces formed by the first antenna element are non-orthogonal to each polarized surface of each of a vertically polarized wave and a horizontally polarized wave in radio waves. The mobile antenna system comprises a second mobile antenna including a second electrically conductive antenna element. The second antenna element has a second portion with one end and the other end extending therefrom. The one end of the second portion is arranged at the body of the vehicle and is electrically connected to a second feeding point. The other end of the second portion is arranged along a surface of any one of the first window and the second window such that polarized surfaces formed by the second antenna element are non-orthogonal to each polarized surface of each of the vertically polarized wave and the horizontally polarized wave in the radio waves. The second mobile antenna is substantially symmetrically placed in the body of the vehicle.

According to a further aspect of the present invention, there is provided an electrically conductive body of a vehicle. The body includes a roof portion, a pillar portion, a corner portion at which the roof portion and the pillar portion meet. The roof portion, the pillar portion, and the corner portion support at least corner portion of a window of the vehicle. The body also includes a mobile antenna provided with an electrically conductive antenna element. The antenna element has a first portion with one end and the other end extending therefrom. The one end of the first portion is arranged at least adjacent to any one of the roof portion, the pillar portion, and the corner portion. The one end of the first portion is electrically connected to a feeding point. The other end of the first portion is arranged along a surface of the window such that polarized surfaces formed by the antenna element are non-orthogonal to each polarized surface of each of a vertically polarized wave and a horizontally polarized wave in radio waves.

### BRIEF DESCRIPTION OF THE DRAWINGS

Other objects and aspects of the invention will become apparent from the following description of embodiments with reference to the accompanying drawings in which:

FIG. 1 is a view schematically illustrates a mobile antenna according to a first embodiment of the present invention;

FIG. 2A is a schematically perspective view of a vehicle on which the mobile antenna according to the first embodiment is mounted;

FIG. 2B is a view schematically illustrating polarized surfaces of the mobile antenna, and those of vertically polarized waves and horizontally polarized waves,

FIG. 3A is a view schematically illustrating the measurement result of horizontal-plane directional patterns of the mobile antenna according to the first embodiment;

FIG. 3B is a view schematically illustrating the measurement result of horizontal-plane directional patterns of a mobile antenna illustrated in FIG. 14B;

FIG. 3C is a view schematically illustrating the measurement result of horizontal-plane directional patterns of a mobile antenna illustrated in FIG. 4;

FIG. 4 is a view schematically illustrates a mobile antenna according to a comparative example with respect to the present invention;

FIG. 5 is a graph schematically illustrating the measurement result of VSWRs of the mobile antenna according to the first embodiment;

FIG. 6 is a view schematically illustrating an antenna system mounted on the body frame according to a first modification of the first embodiment;

FIG. 7 is a view schematically illustrating an antenna system mounted on the body frame according to a second modification of the first embodiment;

FIG. 8 is a view schematically illustrating an antenna system mounted on the body frame according to a third modification of the first embodiment;

FIG. 9 is a view schematically illustrating an antenna system mounted on the body frame according to a fourth modification of the first embodiment;

FIG. 10 is a view schematically illustrating an antenna system mounted on a body frame according to a fifth modification of the first embodiment;

FIG. 11 is a view schematically illustrating an antenna system mounted on the body frame according to a sixth modification of the first embodiment;

FIG. 12 is a view illustrating a mobile antenna according to a still further modification of the first embodiment;

FIG. 13A is a view schematically illustrating a modification of a configuration of an antenna element of the mobile antenna according to the first embodiment;

FIG. 13B is a view schematically illustrating another modification of the configuration of the antenna element of the mobile antenna according to the first embodiment;

FIG. 14A is a view schematically illustrating a further modification of the configuration of the antenna element of the mobile antenna according to the first embodiment;

FIG. 14B is a view schematically illustrating a still further modification of the configuration of the antenna element of the mobile antenna according to the first embodiment;

FIG. 14C is a view schematically illustrating a still further modification of the configuration of the antenna element of the mobile antenna according to the first embodiment;

FIG. 15A is a view schematically illustrating a concrete example of the configuration of the antenna element of the mobile antenna illustrated in FIG. 14C;

FIG. 15B is a view schematically illustrating a comparative example of an antenna element with respect to the antenna element illustrated in FIG. 15A;

FIG. 16A is a smith chart illustrating the measurement result of impedance variation range with respect to ground angles of the antenna element illustrated in FIG. 15A;

FIG. 16B is a smith chart illustrating the measurement result of impedance variation range with respect to corresponding ground angles of the antenna element illustrated in FIG. 15B;

FIG. 17A is a view schematically illustrating a modification of the antenna element of the mobile antenna illustrated in FIG. 15A;

FIG. 17B is a view schematically illustrating another modification of the antenna element of the mobile antenna illustrated in FIG. 15A;

FIG. 18A is a view schematically illustrating an example of mount structures of the ground points of the mobile antenna illustrated in FIG. 15A;

FIG. 18B is a view schematically illustrating a comparison example of mount structures of the ground points of the mobile antenna illustrated in FIG. 15A;

FIG. 19A is a view schematically illustrates a mobile antenna according to a second embodiment of the present invention;

FIG. 19B is a view schematically illustrates a modification of the mobile antenna according to the second embodiment;

FIG. 19C is a view schematically illustrates another modification of the mobile antenna according to the second embodiment;

FIG. 20A is a view schematically illustrating a modification of the configuration of the antenna element of the mobile antenna according to the second embodiment;

FIG. 20B is a view schematically illustrating another modification of the configuration of the antenna element of the mobile antenna according to the second embodiment;

FIG. 20C is a view schematically illustrating a further modification of the configuration of the antenna element of the mobile antenna according to the second embodiment;

FIG. 21A is a view schematically illustrating a mobile antenna according to a further modification of the second embodiment;

FIG. 21B is a view schematically illustrating a mobile antenna according to a still further modification of the second embodiment;

FIG. 21C is a view schematically illustrating a mobile antenna according to a still further modification of the second embodiment;

FIG. 22A is a view schematically illustrates a mobile antenna according to a third embodiment of the present invention;

FIG. 22B is a view schematically illustrates a modification of the mobile antenna according to the third embodiment;

FIG. 22C is a view schematically illustrates another modification of the mobile antenna according to the third embodiment; and

FIG. 23 is a view schematically illustrating a modification of the present invention.

### DETAILED DESCRIPTION OF EMBODIMENTS OF THE INVENTION

Embodiments of the present invention will be described hereinafter with reference to the accompanying drawings.

Note that the terms “front”, “rear” or “back”, “left”, “right”, “upper” or “top”, and “lower” or “bottom”, are used herein to refer to various directions based on a driver or a human operator sitting behind a steering wheel of the vehicle.

### First Embodiment

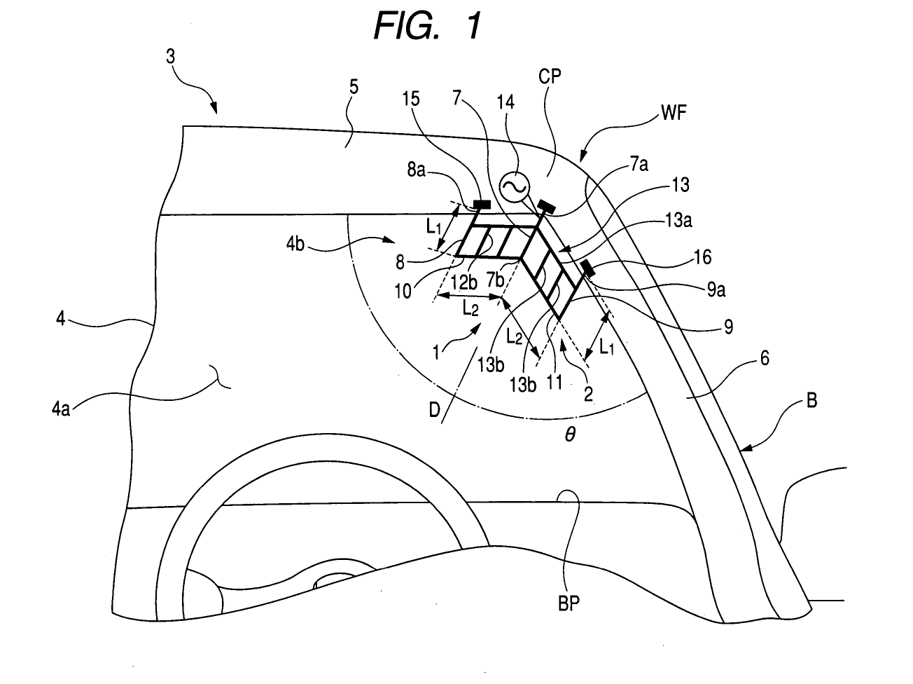

FIG. 1 schematically illustrates a mobile antenna 1 according to a first embodiment of the present invention, which is mounted on an electrically-conductive body frame B of a vehicle, such as a passenger car, 3.

As illustrated in FIG. 1, the mobile antenna 1 is formed as, for example, a film antenna. Specifically, the mobile antenna 1 is provided with an antenna element 2, which can be produced from any electrically conductive member, such as a wire, a rod, a tube, or the like, and formed in a loop. The antenna element 2 is, for example, attached on an inner surface 4a of a rectangular front windshield (windshield glass) 4 through, for example, a film member. The antenna element 2 is located at, for example, the upper-right corner portion 4b of the inner surface 4a of the front windshield 4.

The body frame B is provided with a front windshield frame portion WF. The front windshield frame WF is composed of a front edge of a roof panel 5 (top portion), and a bottom portion BP opposite to the top portion. In addition, the front windshield frame WF is composed of a right portion (right front pillar 6) joined to the top and bottom portions, and a left portion (left front pillar 20, see FIG. 6) joined to the top and bottom portions and opposite to the right portion. The front windshield frame portion WF is configured to support the front windshield 4.

The upper-right corner portion 4b is close to but away from the upper-right corner portion CP at which one end (right end) of the front edge of a roof panel 5 of the body frame B and the upper end of the windshield-side edge of a right front pillar 6 thereof meet.

The antenna element 2 has a linear inner element portion 7, a pair of linear outer element portions 8 and 9, and a pair of linear connection element portions 10 and 11.

The inner element portion 7 has one end 7a and the other end 7b. The inner element portion 7 is arranged along the center direction D of a corner angle θ formed by the front edge of the roof panel 5 and the windshield-side edge of the right front pillar 6. The one end 7a of the inner element portion 7 is located at least adjacent to the upper-right corner portion CP. A feeding point (feeder) 14 is electrically connected to the one end 7a of the inner element portion 7 such that power is fed to the antenna element 2 through the feeding point 14. The other end 7b of the inner element portion 7 is arranged on the center direction D of the corner angle θ.

One end of each of the connection element portions 10 and 11 is joined to the other end 7b of the inner element portion 7. The connection element portion 10 is arranged to be parallel to the front edge of the roof panel 5, and the other end of the connection electric portion 10 is joined to one end of the outer element portion 8. The connection element portion 11 is arranged to be parallel to the windshield-side edge of the right front pillar 6, and the other end of the connection element portion 11 is joined to one end of the outer element portion 9.

The outer element portion 8 is arranged to be parallel to the inner element portion 7. The other end 8a of the outer element portion 8 extends onto the front edge of the roof panel 5.

Moreover, the antenna element 2 has a pair of ground points 15 and 16. The ground point 15 is mounted on an inner surface of the front edge of the roof panel 5 so as to be grounded thereto. The ground point 15 is arranged to be electrically connected to the other end 8a of the outer element portion 8.

In addition, the outer element portion 9 is arranged to be parallel to the inner element portion 7. The other end 9a of the outer element portion 9 extends onto the right front pillar 6. The ground point 16 is mounted on an inner surface of the windshield-side edge of the right front pillar 6 so as to be grounded thereto. The ground point 16 is arranged to be electrically connected to the other end 9a of the outer element portion 9.

Furthermore, the antenna element 2 has a pair of mesh portions 12 and 13.

The mesh portion 12 is composed of a linear element portion 12a. For example, the liner element portion 12a is arranged to be substantially parallel to the front edge of the roof panel 5 with clearances therebetween. The linear element portion 12a is joined between an intermediate portion of the inner element portion 7 and that of the outer element portion 8.

The mesh portion 12 is also composed of a plurality of, such as two, bars 12b. The bars 12b are joined between the connection element portion 10 and the linear element portion 12a to be parallel to the inner element portion 7 such that they have intervals along the connection element portion 10 (linear element portion 12a). Specifically, as illustrated in FIG. 1, the inner element portion 7, the connection element portion 10, the outer element portion 8, the linear element portion 12a, and the bars 12b provide a plurality of current paths.

Similarly, the mesh portion 13 is composed of a linear element portion 13a. For example, the liner element portion 13a is arranged to be substantially parallel to the windshield-side edge of the right front pillar 6 with clearances therebetween.

The linear element portion 13a is joined between an intermediate portion of the inner element portion 7 and that of the outer element portion 9.

In addition, the mesh portion 13 is also composed of a plurality of, such as two, bars 13b. The bars 13b are joined between the connection element portion 11 and the linear element portion 13a to be parallel to the inner element portion 7 such that they have regular intervals along the connection element portion 11 (linear element portion 13a). Specifically, as illustrated in FIG. 1, the inner element portion 7, the connection element portion 11, the outer element portion 9, the linear element portion 13a, and the bars 13b provide a plurality of current paths (loops).

In the first embodiment, the antenna element 2 is designed to receive radio waves each of which has a predetermined wavelength (target wavelength) with utmost efficiency. Reference character λ is assigned to the predetermined wavelength.

To realize the utmost-efficient receiving of the radio waves each having the wavelength λ, the inner element portion 7, and the outer element portions 8 and 9 are designed to have the same length L1 of 0.15 λ. In addition, to realize that, the connection element portions 10 and 11 are designed to have the same length L2 of 0.2λ.

The lengths of the element portions 7 to 11 of the antenna element 2 are designed with fractional shortening of the wavelength λ due to a dielectric constant of the windshield glass 4; this fractional shortening is set to a value within the range from 0.7 to 0.8. That is, the length L1 of 0.15λ and the length L2 of the 0.2λ are amended by multiplying them by the value within the range from 0.7 to 0.8.

In the structure of the mobile antenna 1, as set forth above, the inner element portion 7, the connection element portions 10 and 11, the outer element portions 8 and 9, and the mesh portions 12 and 13 allow a plurality of paths (loops) that have different path lengths, respectively; these different path lengths provide different antenna lengths. For example, the inner element portion 7, the connection element portion 10, and the outer element portion 8 provide a first current path (loop), and the first current path is designed to have a predetermined length of 0.5λ

$$( \frac{1}{2} λ ) ,$$

which is calculated by “L1×2+L2”.

Similarly, the inner element portion 7, the connection element portion 11, and the outer element portion 9 provide a second current path (loop), and the second current path is designed to have a predetermined length of 0.5λ

$$( \frac{1}{2} λ ) ,$$

which is calculated by “L1×2+L2”.

The path length

$$( \frac{1}{2} λ )$$

of each of the first and second current paths allows the radio waves each with the wavelength λ to be effectively received by each of the first and second current paths (loops).

In addition, the one end 7a of the inner element portion 7, the linear element portion 12a, and the other end 8a of the outer element portion 8 provide a third current path (loop). A path length of the third current path is different from the first path length, so that the resonance frequency corresponding to the third current path is different from that corresponding to the first current path.

Similarly, the one end 7a of the inner element portion 7, the linear element portion 13a, and the other end 9a of the outer element portion 9 provide a fourth current path (loop). A path length of the fourth current path is different from the second path length, so that the resonance frequency corresponding to the fourth current path is different from that corresponding to the second current path.

Specifically, these different path lengths (antenna lengths) provided by the antenna element 2 have corresponding different resonant frequencies, respectively; these different resonant frequencies correspond to a broad frequency band.

In addition, the clearances between the front edge of the roof panel 5 (body frame B) acting as ground and the linear element portion 12a of the antenna element 2 are adjusted in consideration of changes of capacitive components occurring between the roof panel 5 (body frame B) and the linear element portion 12a. This is because the capacitive components between the roof panel 5 and the linear element portion 12a vary depending on the changes of the clearances therebetween.

Similarly, the clearances between the windshield-side edge of the right front pillar 6 (body frame B) acting as ground and the linear element portion 13a of the antenna element 2 are adjusted in consideration of changes of capacitive components occurring between the right front pillar 6 (body frame B) and the linear element portion 13a of the antenna element 2. This is because the capacitive components between the right front pillar 6 and the linear element portion 13a vary depending on the changes of the clearances therebetween.

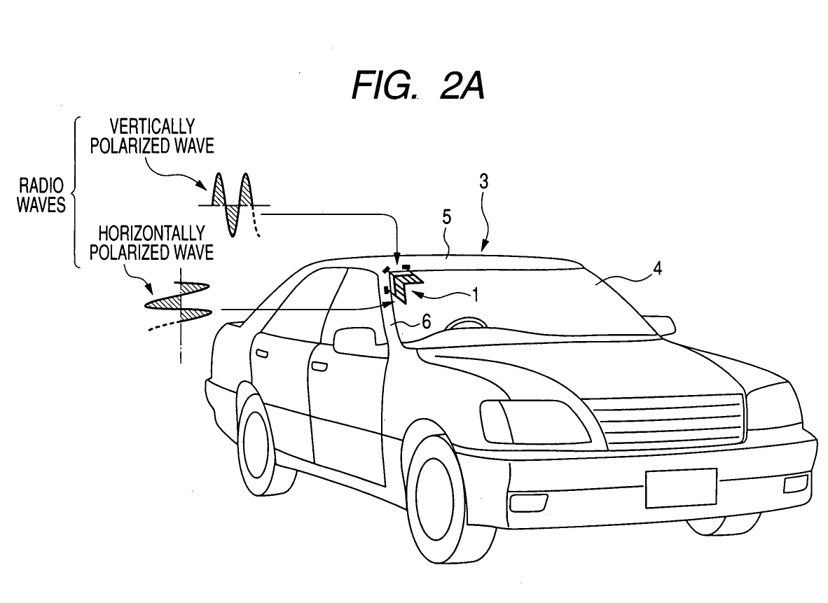

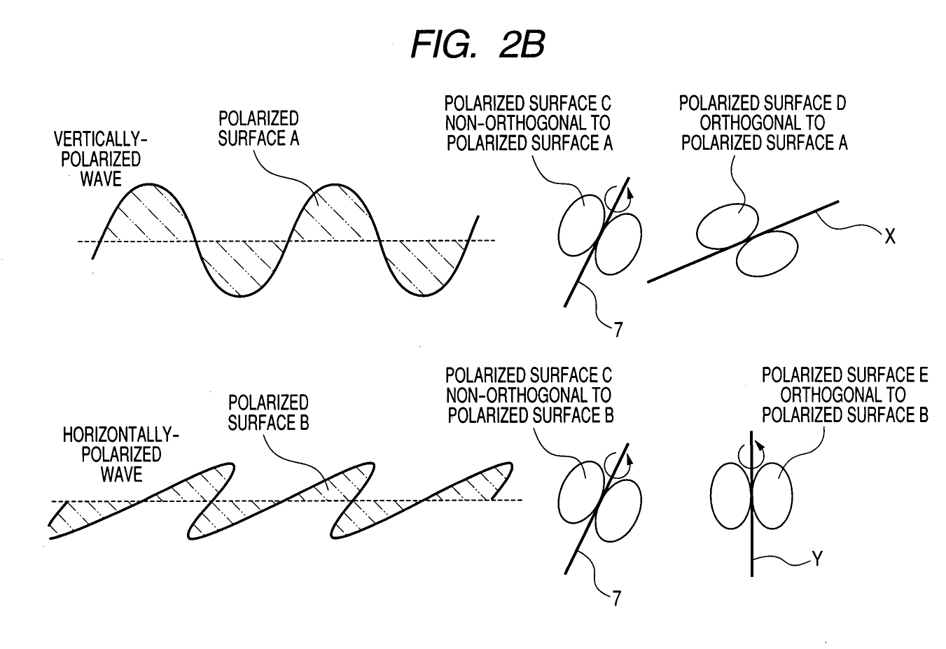

Operations of the mobile antenna 1 will be described hereinafter with reference to FIGS. 2 to 5.

In the structure of the mobile antenna 1, when power fed to the antenna element 2 through the feeding point 14 allows an antenna current to flow through the inner element portion 7 from the feeding point 14.

The inner element portion 7 is arranged along the center direction D of the corner angle θ, so that it is inclined to the vertical and horizontal directions with respect to the ground surface. This structure allows, as shown in FIGS. 2A and 2B, polarized surfaces C of the inner element portion 7 of the antenna element 2 to be non-orthogonal to each polarized surface A of each vertically polarized wave and each polarized surface B of each horizontally polarized wave in the radio waves.

In addition, the antenna element 2 is located at the corner portion 4b of the inner surface 4a of the front windshield 4, which is close to the upper-right corner portion CP formed by the front edge of the roof panel 5 and the upper end of the windshield-side edge of the right front pillar 6.

This structure of the mobile antenna 1 mounted on the vehicle's body frame B allows vertically and horizontally polarized waves to be effectively received when they are transmitted from the front side of the vehicle 3.

Furthermore, when vertically and horizontally polarized waves are transmitted from the rear side of the vehicle 3, the mobile antenna 1 permits the transmitted vertically polarized waves, which are diffracted by the roof panel 5 to enter into the interior of the vehicle 3, to be effectively received by the antenna element 2. This is because the antenna element 2 is arranged close to the roof panel 5 of the vehicle and each polarized surface C of the inner element portion 7 of the antenna element 2 is not to be orthogonal but to be crossed, at approximately 45 degrees, to each of the polarized surfaces A of he vertically polarized waves. In contrast, if an inner element portion (see X in FIG. 2B) is arranged such that each polarized surface D is orthogonal to each polarized surface A of each vertically polarized wave, the inner element portion X cannot receive the vertically polarized waves.

In addition, the mobile antenna 1 permits the transmitted horizontally polarized waves, which are diffracted by the right-side of the vehicle to enter into the interior thereof, to be effectively received by the antenna element 2. This is because the antenna element 2 is arranged close to the right-side of the vehicle and each polarized surface of the inner element portion 7 of the antenna element 2 is not to be orthogonal but to be crossed, at approximately 45 degrees, to each of the polarized surfaces B of the horizontally polarized waves. In contrast, if an inner element portion (see Y in FIG. 2B) is arranged such that each polarized surface E is orthogonal to each polarized surface B of each horizontally polarized wave, the inner element portion Y cannot receive the horizontally polarized waves.

That is, it is possible for the mobile antenna 1 according to the first embodiment to effectively receive both the vertically polarized waves and the horizontally polarized waves transmitted from both the front side of the vehicle and the rear side thereof.

Moreover, the antenna current passing through the inner element portion 7 branches to flow through the connection element portion 10 and the outer element portion 8 into the ground point 15 in loop, and to flow through the connection portion 11 and the outer connection element 9 into the ground point 16 in loop.

The current component flowing through the loop (first loop) formed by the inner element portion 7, the connection element portion 10, and the outer element portion 8 allows detection of magnetic field components of the radio waves; the magnetic field components are directed to be orthogonal to the loop area. In addition, the current component flowing through the first loop allows detection of magnetic field formed by high-frequency currents flowing through the body frame B.

Similarly, the current component flowing through the loop (second loop) formed by the inner element portion 7, the connection element portion 11, and the outer element portion 9 allows detection of magnetic field components of the radio waves; the magnetic field components are directed to be orthogonal to the loop area. In addition, the current component flowing through the second loop allows detection of magnetic field formed by the high-frequency currents flowing through the body frame B.

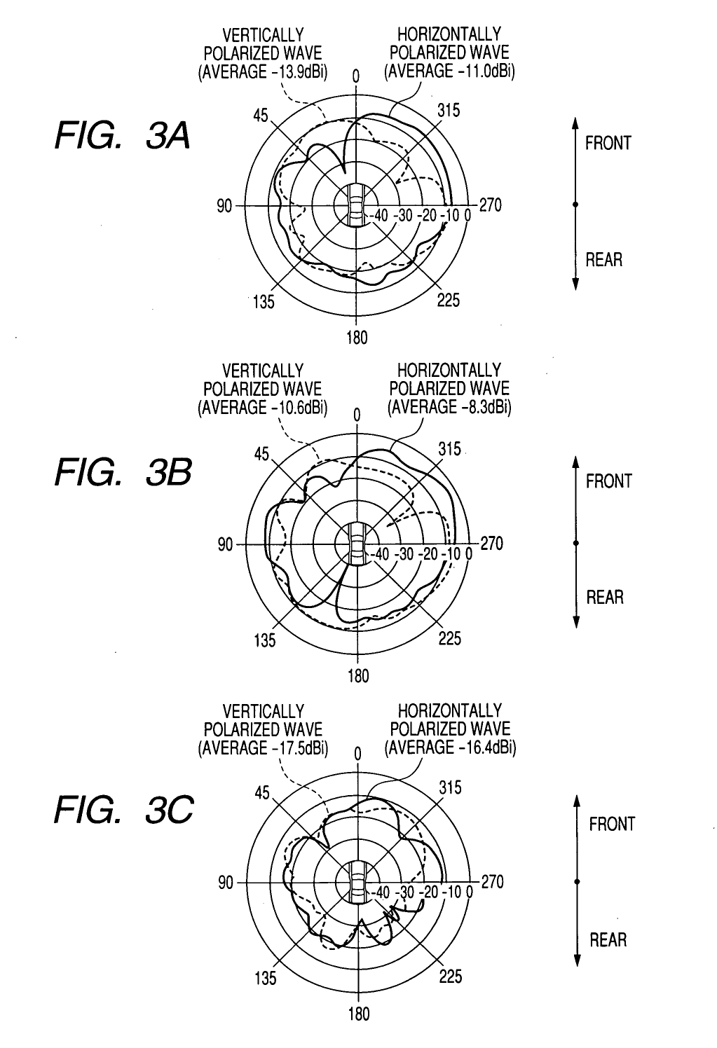

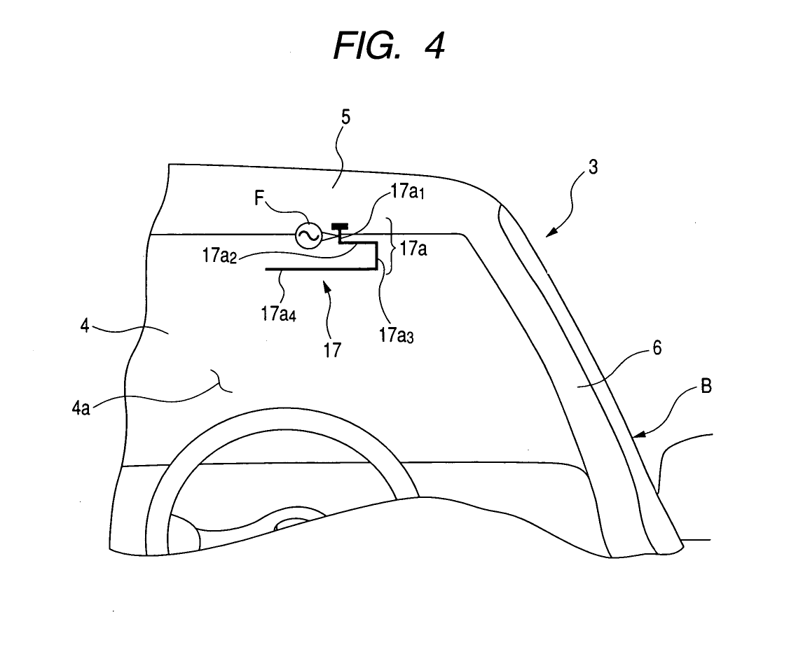

FIG. 3 shows the measurement result of horizontal-plane directional patterns of the mobile antenna 1 and that of horizontal-plane directional patterns of a mobile antenna disclosed in FIG. 4, which is a comparative example. As illustrated in FIG. 4, a mobile antenna (monopole antenna) 17 according to the comparative example has an antenna element 17a. The antenna element 17a is attached on the inner surface 4a of the front windshield 4. The antenna element 17a is located at the upper edge of the inner surface 4a of the front windshield 4. The antenna element 17a is composed of a first linear element portion 17a1 crept downwardly along the inner surface 4a of the windshield 4; one end of the first linear element portion 17a1 is electrically connected to a feeding point F through which power is fed to the antenna element 17a.

The antenna element 17a is composed of a second linear element portion 17a2 extending from the other end of the first linear element portion 17a1 rightward along the inner surface 4a of the windshield 4. The antenna element 17a is composed of a third linear element portion 17a3 extending from the extending end of the second linear element portion 17a2 downwardly along the inner surface 4a of the windshield 4. In addition, the antenna element 17a is composed of a fourth linear element portion 17a4 extending from the extending end of the third linear element portion 17a3 in parallel to the first linear element portion 17a1 along the inner surface 4a of the windshield 4. The mobile antenna 17 is designed as a harmonic exciting antenna such that an overall length of the antenna element 17a is designed to

$$( \frac{1}{4} λ )$$

that resonates with half or quarter of a desired frequency.

Specifically, FIG. 3A illustrates the measurement result of horizontal-plane directional patterns of the mobile antenna 1, and FIG. 3c illustrates the measurement result of horizontal-plane directional patterns of the mobile antenna 17 shown in FIG. 4.

As apparent in FIGS. 3A and 3C, directional gains of the antenna 17 are biased to the front windshield side (the front side of the vehicle 3).

In contrast, in the first embodiment, high directional gains are obtained to not only the front windshield side (the front side of the vehicle 3) to which the mobile antenna 1 is mounted, but also to the opposite side (the rear side of the vehicle 3). That is, the mobile antenna 1 according to the first embodiment can provide good and hardly-biased directional gains. This is because the antennal element 2 can effectively receive both the vertically polarized waves, which are transmitted from the rear side of the vehicle 3 to be diffracted by the roof panel 5, and the horizontally polarized waves, which are transmitted from the rear side thereof to be diffracted by the right side of the vehicle body B.

In addition, in the first embodiment, loss resistance of the antenna element 2 is smaller than that of the antenna element 17a, and receiving efficiency of the antenna element 2 is higher than that of the antenna element 17a. This may be because each current path length of the antenna element 2 is shorter than the current path length of the antenna element 17a. These characteristics cause an average gain of the mobile antenna 1 with respect to the vertically-polarized waves to become −13.9 dB, which is more improved than an average gain of −17.5 dB of the mobile antenna 17 with respect to vertically-polarized waves. Similarly, these characteristics cause an average gain of the mobile antenna 1 with respect to the horizontally-polarized waves to become −11.0 dB, which is more improved than an average gain of −16.4 dB of the mobile antenna 17 with respect to horizontally-polarized waves.

That is, the structure of the mobile antenna 1 allows its average gains with respect to vertically-polarized waves and horizontally-polarized waves to be improved as compared with the average gains of the mobile antenna 17 with respect to them.

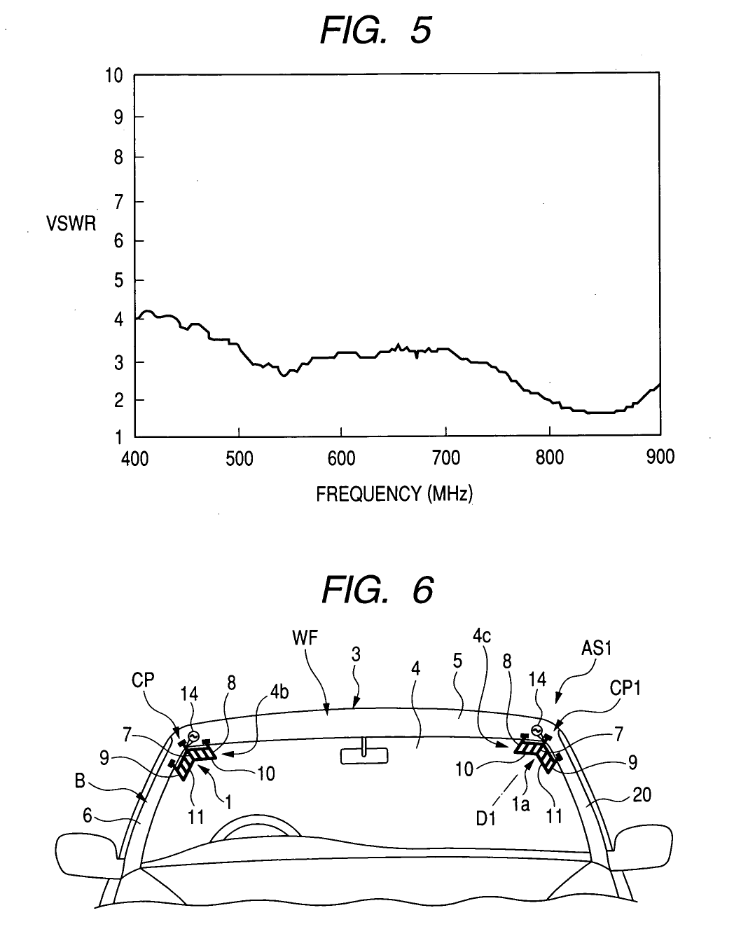

In addition, FIG. 5 illustrates the measurement result of VSWRs (Voltage Standing Wave Ratios) of the mobile antenna 1 according to the first embodiment. The VSWR represents the ratio of the voltage (or current) maximum at any point on a transmission line in which reflection waves are generated due to impedance mismatching to the voltage (or current) minimum at that point.

As illustrated in FIG. 5, lower VSWRs of the mobile antenna 1 have been obtained within the target frequency range of, for example, 470 to 770 MHz corresponding to UHF band, allowing the bandwidth of the mobile antenna 1 to be smoothly wider.

FIG. 6 schematically illustrates an antenna system AS1 mounted on the body frame B according to a first modification of the first embodiment.

As illustrated in FIG. 6, the antenna system AS1 is provided with the mobile antenna 1 according to the first embodiment, which is mounted at the upper-right corner portion 4b of the inner surface 4a of the front windshield 4.

In addition, the antenna system AS1 is provided with a mobile antenna 1a whose structure is a substantially symmetrical to the structure of the mobile antenna 1, and each element of the mobile antenna 1a is substantially identical with that of the mobile antenna 1. Reference characters, which are assigned to the elements of the mobile antenna 1, are assigned to the corresponding elements of the mobile antenna 1a.

The mobile antenna 1a is substantially symmetrically placed in the vehicle 3 with respect to the mobile antenna 1 in the horizontal (lateral) direction of the vehicle 3.

Specifically, the mobile antenna 1a is mounted at the upper-left corner portion 4c of the inner surface 4a of the front windshield 4. The upper-left corner portion 4c is close to but away from the upper-left corner portion CP1 at which one end (left end) of the front edge of the roof panel 5 of the body frame B and the upper end of the windshield-side edge of the left front pillar 20 thereof meet.

The inner element portion 7 of the antenna element 2 is arranged along the center direction D1 of a corner angle formed by the front edge of the roof panel 5 and the windshield-side edge of the left front pillar 20. The one end 7a of the inner element portion 7 is located at the upper-left corner portion CP1. The other end 7b of the inner element portion 7 is arranged on the center direction D1 of the corner angle. The connection element portion 10 is arranged to be parallel to the front edge of the roof panel 5, and the connection element portion 11 is arranged to be parallel to the windshield-side edge of the left front pillar 20. Because other structures of the antenna element 2 of the mobile antenna 1a are substantially the same as those of the antenna element 2 of the mobile antenna 1, descriptions of which are omitted.

As described above, the mobile antennas 1 and 1a of the antenna system AS1 are symmetrically mounted on the upper-right and upper-left corners 4b and 4c of the front windshield 4, which are horizontally spaced. The antenna system AS1 provides space diversity that can achieve space diversity effect, making it possible to further improve the receiving efficiency of the vehicle 3 with respect to radio waves transmitted from both the front side and rear side of the vehicle 3.

In addition, directions in which antenna current components flow through the antenna element 2 of the mobile antenna 1 and those in which antenna current components flow through the antenna element 2 of the mobile antenna 1a are different from each other. This can provide different polarized surfaces, making it possible to achieve polarization-diversity effect.

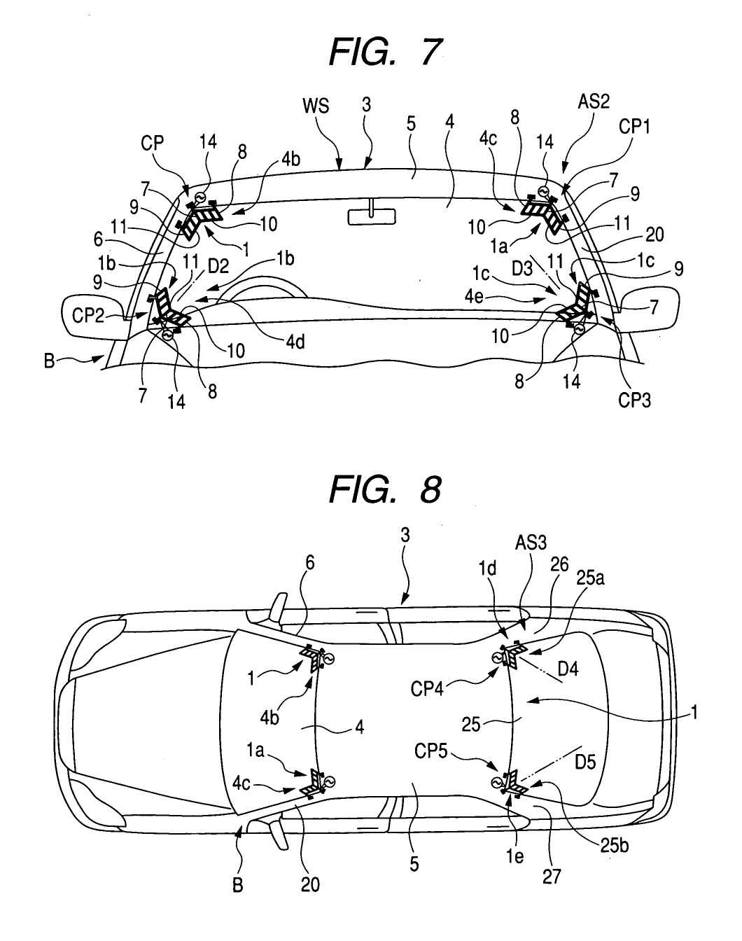

FIG. 7 schematically illustrates an antenna system AS2 mounted on the body frame B according to a second modification of the first embodiment.

As illustrated in FIG. 7, the antenna system AS2 is provided with the mobile antenna 1, which is mounted at the upper-right corner portion 4b of the inner surface 4a of the front windshield 4, and the mobile antenna 1a, which is mounted at the upper-left corner portion 4c of the inner surface 4a of the front windshield 4.

In addition, the antenna system AS2 is provided with a mobile antenna 1b whose structure is a substantially symmetrical to the structure of the mobile antenna 1, and each element of the mobile antenna 1b is substantially identical with that of the mobile antenna 1. Reference characters, which are assigned to the elements of the mobile antenna 1, are assigned to the corresponding elements of the mobile antenna 1b.

The mobile antenna 1b is symmetrically placed in the vehicle 3 with respect to the mobile antenna 1 along the right front pillar 6.

Specifically, the mobile antenna 1b is mounted at the lower-right corner portion 4d of the inner surface 4a of the front windshield 4. The lower-right corner portion 4d is close to but away from a lower-right corner portion CP2 of the front windshield frame portion WF at which one end (right end) of the bottom portion BP and the lower end of the windshield-side edge of the right front pillar 6 meet.

The inner element portion 7 of the antenna element 2 of the mobile antenna 1b is arranged along the center direction D2 of a corner angle formed by the bottom portion BP of the front windshield frame portion WF and the windshield-side edge of the right front pillar 6. The one end 7a of the inner element portion 7 is located at the lower-right corner portion CP2. The other end 7b of the inner element portion 7 is arranged on the center direction D2 of the corner angle. The connection element portion 10 is arranged to be parallel to the bottom portion BP of the front windshield frame portion WF, and the connection element portion 11 is arranged to be parallel to the windshield-side edge of the right front pillar 6. Because other structures of the antenna element 2 of the mobile antenna 1b are substantially the same as those of the antenna element 2 of the mobile antenna 1, descriptions of which are omitted.

Furthermore, the antenna system AS2 is provided with a mobile antenna 1c whose structure is a substantially symmetrical to the structure of the mobile antenna 1, and each element of the mobile antenna 1b is substantially identical with that of the mobile antenna 1. Reference characters, which are assigned to the elements of the mobile antenna 1, are assigned to the corresponding elements of the mobile antenna 1b.

The mobile antenna 1c is symmetrically placed in the vehicle 3 with respect to the mobile antenna 1a along the left front pillar 20.

Specifically, the mobile antenna 1c is mounted at the lower-left corner portion 4e of the inner surface 4a of the front windshield 4. The lower-left corner portion 4e is close to but away from a lower-left corner portion CP3 of the front windshield frame portion WF at which one end (left end) of the bottom portion BP and the lower end of the windshield-side edge of the left front pillar 20 meet.

The inner element portion 7 of the antenna element 2 of the mobile antenna 1c is arranged along the center direction D3 of a corner angle formed by the bottom portion BP of the front windshield frame portion WP and the windshield-side edge of the left front pillar 20. The one end 7a of the inner element portion 7 is located at the lower-left corner portion CP3. The other end 7b of the inner element portion 7 is arranged on the center direction D3 of the corner angle. The connection element portion 10 is arranged to be parallel to the bottom portion BP of the front windshield frame portion WF, and the connection element portion 11 is arranged to be parallel to the windshield-side edge of the left front pillar 20. Because other structures of the antenna element 2 of the mobile antenna 1b are substantially the same as those of the antenna element 2 of the mobile antenna 1, descriptions of which are omitted.

As described above, the mobile antennas 1 and 1a are symmetrically mounted on the upper-right and upper-left corners 4b and 4c of the front windshield 4, which are horizontally spaced. In addition, the mobile antennas 1b and 1c are symmetrically mounted on the lower-right and lower-left corners 4d and 4e of the front windshield 4, which are horizontally spaced.

The mobile antennas 1 and 1b of the antenna system AS2 are symmetrically mounted on the upper-right and lower-right corners 4b and 4d of the front windshield 4, which are substantially vertically spaced. Furthermore, the mobile antennas 1a and 1c of the antenna system AS2 are symmetrically mounted on the upper-left and lower-left corners 4c and 4e of the front windshield 4, which are substantially vertically spaced.

The antenna system AS2, therefore, provides space diversity that can achieve space diversity effect, making it possible to further improve the receiving efficiency of the vehicle 3 with respect to radio waves transmitted from both the front side and rear side of the vehicle 3.

In addition, antenna-current flow directions in the antenna elements 2 of the mobile antennas 1, 1a, 1b, and 1c are different from each other. This can provide different polarized surfaces, making it possible to achieve polarization-diversity effect.

FIG. 8 schematically illustrates an antenna system AS3 mounted on the body frame B according to a third modification of the first embodiment.

As illustrated in FIG. 8, the antenna system AS3 is provided with the mobile antenna 1, and the mobile antenna 1a, which are mounted at the upper-right and upper-left corner portions 4b and 4c of the inner surface 4a of the front windshield 4, respectively.

In addition, the antenna system AS3 is provided with mobile antennas 1d and 1e whose structures are substantially symmetrical to the structure of the mobile antenna 1, and each element of each of the mobile antennas 1d and 1e is substantially identical with that of the mobile antenna 1. Reference characters of the elements of each of the mobile antennas 1d and 1e are therefore omitted in FIG. 8, keeping the viewability of FIG. 8 clear.

The body frame B is provided with a rear window frame portion WF1. The rear window frame portion WF1 is composed of a rear edge of the roof panel 5 (top portion), and a bottom portion opposite to the top portion. The rear window frame portion WF1 is also composed of a right portion (right rear pillar 26) joined to the top and bottom portions, and a left portion (left rear pillar 27) joined to the top and bottom portions and opposite to the right portion. The rear window frame portion WF1 is configured to support the rear window 25.

The mobile antenna 1d is symmetrically placed in the vehicle 3 with respect to the mobile antenna 1 in the longitudinal direction of the vehicle 3.

Specifically, the mobile antenna 1d is mounted at the upper-right corner portion 25a of an inner surface of the rear window 25. The upper-right corner portion 25a is close to but away from the upper-right corner portion CP4 at which one end (right end) of the rear edge of the roof panel 5 of the body frame B and the upper end of the window-side edge of the right rear pillar 26 thereof meet.

The inner element portion 7 of the antenna element 2 is arranged along the center direction D4 of a corner angle formed by the rear edge of the roof panel 5 and the window-side edge of the right rear pillar 26. The one end 7a of the inner element portion 7 is located at the upper-right corner portion CP4. The other end 7b of the inner element portion 7 is arranged on the center direction D4 of the corner angle. The connection element portion 10 is arranged to be parallel to the rear edge of the roof panel 5, and the connection element portion 11 is arranged to be parallel to the window-side edge of the right rear pillar 26. Because other structures of the antenna element 2 of the mobile antenna 1d are substantially the same as those of the antenna element 2 of the mobile antenna 1, descriptions of which are omitted.

In addition, the mobile antenna 1e is symmetrically placed in the vehicle 3 with respect to the mobile antenna 1d in the lateral (horizontal) direction of the vehicle 3.

Specifically, the mobile antenna 1e is mounted at the upper-left corner portion 25b of the inner surface of the rear window 25. The upper-left corner portion 25b is close to but away from the upper-left corner portion CP5 at which one end (left end) of the rear edge of the roof panel 5 of the body fame B and the upper end of the window-side edge of the left rear pillar 27 thereof meet.

The inner element portion 7 of the antenna element 2 is arranged along the center direction D5 of a corner angle formed by the rear edge of the roof panel 5 and the window-side edge of the left rear pillar 27. The one end 7a of the inner element portion 7 is located at the upper-left corner portion CP5. The other end 7b of the inner element portion 7 is arranged on the center direction D5 of the corner angle. The connection element portion 10 is arranged to be parallel to the rear edge of the roof panel 5, and the connection element portion 11 is arranged to be parallel to the window-side edge of the left rear pillar 27. Because other structures of the antenna element 2 of the mobile antenna 1e are substantially the same as those of the antenna element 2 of the mobile antenna 1, descriptions of which are omitted.

As described above, the mobile antennas 1 and 1a are symmetrically mounted on the upper-right and upper-left corners 4b and 4c of the front windshield 4, which are horizontally spaced. In addition, the mobile antennas 1d and 1e are symmetrically mounted on the upper-right and upper-left corners 25a and 25b of the rear window 25, which are horizontally spaced.

The mobile antennas 1 and 1d of the antenna system AS3 are symmetrically mounted on the upper-right corers 4b and 25a of the front windshield 4 and the rear window 25, which are spaced in the longitudinal direction of the vehicle 3. Similarly, the mobile antennas 1a and 1e of the antenna system AS3 are symmetrically mounted on the upper-left corers 4c and 25b of the front windshield 4 and the rear window 25, which are spaced in the longitudinal direction of the vehicle 3.

The antenna system AS3, therefore, provides space diversity that can achieve space diversity effect, making it possible to further improve the receiving efficiency of the vehicle 3 with respect to radio waves transmitted from both the front side and rear side of the vehicle 3.

In addition, antenna-current flow directions in the antenna elements 2 of the mobile antennas 1, 1a, 1d, and 1e are different from each other. This can provide different polarized surfaces, making it possible to achieve polarization-diversity effect.

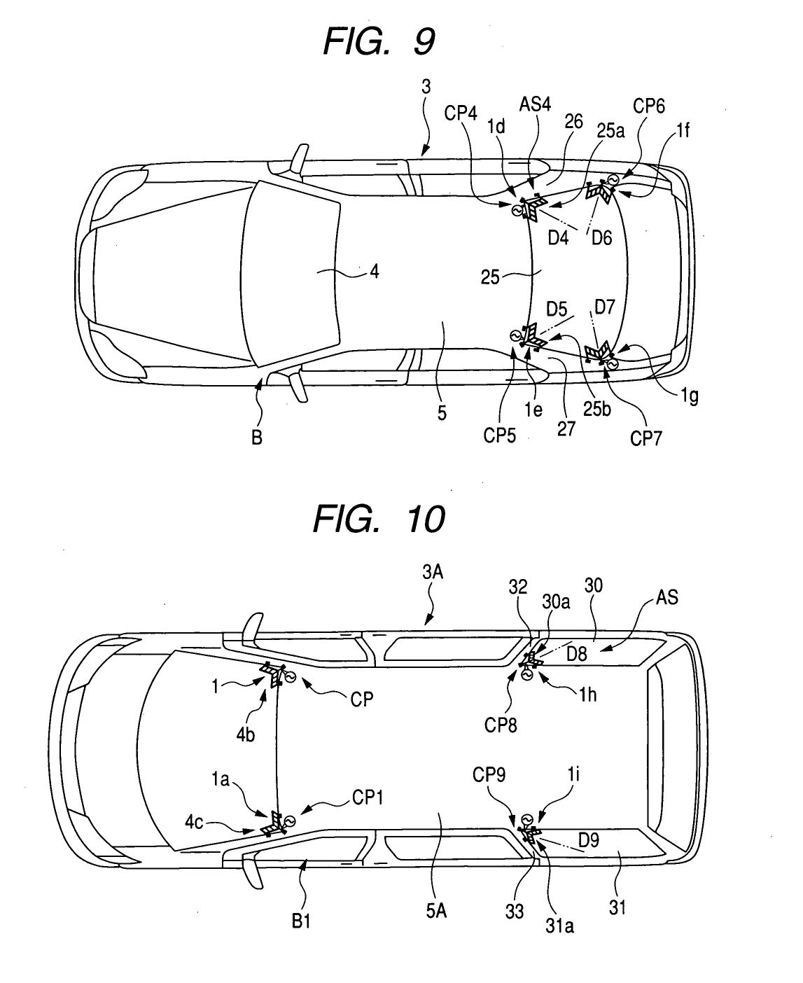

FIG. 9 schematically illustrates an antenna system AS4 mounted on the body frame B according to a fourth modification of the first embodiment.

As illustrated in FIG. 9, the antenna system AS4 is provided with the mobile antennas 1d and 1e, which are mounted at the upper-right and upper-left corner portions 25a and 25b of the inner surface of the rear window 25.

In addition, the antenna system AS4 is provided with mobile antennas 1f and 1g whose structures are substantially symmetrical to the structure of the mobile antenna 1, and each element of each of the mobile antennas 1f and 1g is substantially identical with that of the mobile antenna 1. Reference characters of the elements of each of the mobile antennas 1f and 1g are therefore omitted in FIG. 9, keeping the viewability of FIG. 9 clear.

Specifically, the mobile antenna 1f is mounted at the lower-right corner portion 25c of the inner surface of the rear window 25. The lower-right corner portion 25c is close to but away from a lower-right corner portion CP6 of the rear window frame portion WF1 at which one end (right end) of the bottom portion and the lower end of the window-side edge of the right front pillar 26 meet.

The inner element portion 7 of the antenna element 2 of the mobile antenna 1f is arranged along the center direction D6 of a corner angle formed by the bottom portion of the rear window frame portion WF1 and the window-side edge of the right rear pillar 26. The one end 7a of the inner element portion 7 is located at the lower-right corner portion CP6. The other end 7b of the inner element portion 7 is arranged on the center direction D6 of the corner angle. The connection element portion 10 is arranged to be parallel to the bottom portion of the front window frame portion WF1, and the connection element portion 11 is arranged to be parallel to the window-side edge of the right rear pillar 26. Because other structures of the antenna element 2 of the mobile antenna 1f are substantially the same as those of the antenna element 2 of the mobile antenna 1, descriptions of which are omitted.

The mobile antenna 1g is symmetrically placed in the vehicle 3 with respect to the mobile antenna 1a along the left rear pillar 27.

Specifically, the mobile antenna 1g is mounted at the lower-left corner portion 25d of the inner surface of the rear window 25. The lower-left corner portion 25d is close to but away from a lower-left corner portion CP7 of the rear window frame portion WF1 at which one end (left end) of the bottom portion and the lower end of the window-side edge of the left rear pillar 27 meet.

The inner element portion 7 of the antenna element 2 of the mobile antenna 1g is arranged along the center direction D7 of a corner angle formed by the bottom portion of the rear window frame portion WF1 and the window-side edge of the left rear pillar 27. The one end 7a of the inner element portion 7 is located at least adjacent to the lower-left corner portion CP7. The feeding point 14 is electrically connected to the one end 7a of the inner element portion 7. The other end 7b of the inner element portion 7 is arranged on the center direction D7 of the corner angle. The connection element portion 10 is arranged to be parallel to the bottom portion of the rear window frame portion WF1, and the connection element portion 11 is arranged to be parallel to the window-side edge of the left rear pillar 27. Because other structures of the antenna element 2 of the mobile antenna 1b are substantially the same as those of the antenna element 2 of the mobile antenna 1, descriptions of which are omitted.

As described above, similar to the former described modifications, the antenna system AS4 according to the fourth modification of the first embodiment provides space diversity and different polarized surfaces because the mobile antennas 1d to 1g are symmetrically arranged on the inner surface of the rear window 25. This makes it possible to further improve the receiving efficiency of the vehicle 3 with respect to radio waves transmitted from both the front side and rear side of the vehicle 3.

FIG. 10 schematically illustrates an antenna system AS5 mounted on a body frame B1 of a station wagon vehicle 3A according to a fifth modification of the first embodiment.

As illustrated in FIG. 10, the antenna system AS5 is provided with the mobile antennas 1 and 1a, which are mounted at the upper-right and upper-left corner portions 4b and 4c of the inner surface of the front window 4.

In addition, the antenna system AS5 is provided with mobile antennas 1h and 1i whose structures are substantially symmetrical to the structure of the mobile antenna 1, and each element of each of the mobile antennas 1h and 1i is substantially identical with that of the mobile antenna 1. Reference characters of the elements of each of the mobile antennas 1f and 1g are therefore omitted in FIG. 10, keeping the viewability of FIG. 10 clear.

The mobile antenna 1h is symmetrically placed in the vehicle 3 with respect to the mobile antenna 1 in the longitudinal direction of the vehicle 3A.

Specifically, the mobile antenna 1h is mounted at one upper corner portion 30a of an inner surface of the right-quarter window 30. The upper-right corner portion 30a is close to but away from the portion CP8 at which the right-quarter window-side edge of a roof panel 5A of the body frame B1 and the upper end of the window-side edge of a right quarter pillar 32 thereof meet.

The inner element portion 7 of the antenna element 2 is arranged along the center direction D8 of a corner angle formed by the right-quarter window-side edge of the roof panel 5A and the window-side edge of the right quarter pillar 32. The one end 7a of the inner element portion 7 is located at least adjacent to the portion CP8. The feeding point 14 is electrically connected to the one end 7a of the inner element portion 7. The other end 7b of the inner element portion 7 is arranged on the center direction D8 of the corner angle. The connection element portion 10 is arranged to be parallel to the right-quarter window-side edge of the roof panel 5A, and the connection element portion 11 is arranged to be parallel to the window-side edge of the right quarter pillar 32. Because other structures of the antenna element 2 of the mobile antenna 1h are substantially the same as those of the antenna element 2 of the mobile antenna 1, descriptions of which are omitted.

In addition, the mobile antenna 1i is symmetrically placed in the vehicle 3A with respect to the mobile antenna 1h in the lateral (horizontal) direction of the vehicle 3A.

Specifically, the mobile antenna 1i is mounted at one upper corner portion 31a of an inner surface of the left-quarter window 31. The corner portion 31a is close to but away from the portion CP9 at which the left-quarter window-side edge of the roof panel 5A of the body frame B1 and the upper end of the window-side edge of a left quarter pillar 33 thereof meet.

The inner element portion 7 of the antenna element 2 is arranged along the center direction D9 of a corner angle formed by the left-quarter window-side edge of the roof panel 5A and the window-side edge of the left quarter pillar 33. The one end 7a of the inner element portion 7 is located at least adjacent to the portion CP9. The feeding point 14 is electrically connected to the one end 7a of the inner element portion 7. The other end 7b of the inner element portion 7 is arranged on the center direction D9 of the corner angle. The connection element portion 10 is arranged to be parallel to the left-quarter window-side edge of the roof panel 5A, and the connection element portion 11 is arranged to be parallel to the window-side edge of the left quarter pillar 33. Because other structures of the antenna element 2 of the mobile antenna 1i are substantially the same as those of the antenna element 2 of the mobile antenna 1, descriptions of which are omitted.

As described above, similar to the former described modifications, the antenna system AS5 according to the fifth modification of the first embodiment provides space diversity and different polarized surfaces because the mobile antennas 1, 1a, 1h, and 1i are symmetrically arranged on the upper side of the vehicle 3A. This makes it possible to further improve the receiving efficiency of the vehicle 3 with respect to radio waves transmitted from both the front side and rear side of the vehicle 3A.

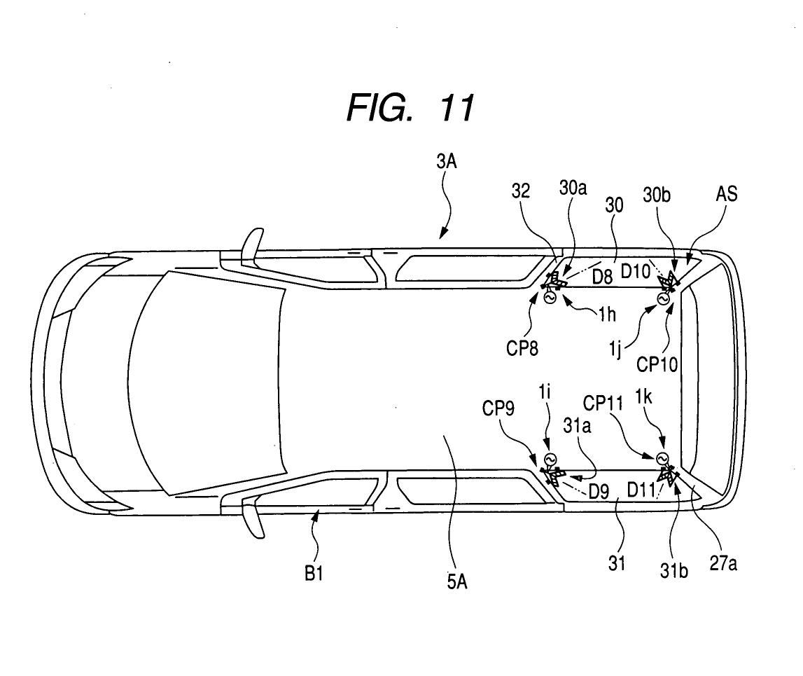

FIG. 11 schematically illustrates an antenna system AS6 mounted on the body frame B1 of the station wagon vehicle 3A according to a sixth modification of the first embodiment.

As illustrated in FIG. 11, the antenna system AS6 is provided with the mobile antennas 1h and 1i, which are mounted at the one upper corner portion of the inner surface of the right quarter window 30 and that of the inner surface of the left quarter window 31.

In addition, the antenna system AS6 is provided with mobile antennas 1j and 1k whose structures are substantially symmetrical to the structure of the mobile antenna 1, and each element of each of the mobile antennas 1j and 1k is substantially identical with that of the mobile antenna 1. Reference characters of the elements of each of the mobile antennas 1j and 1k are therefore omitted in FIG. 11, keeping the viewability of FIG. 11 clear.

The mobile antenna 1j is symmetrically placed in the vehicle 3A with respect to the mobile antenna 1h in the longitudinal direction of the vehicle 3A.

Specifically, the mobile antenna 1j is mounted at the other upper corner portion 30b of the inner surface of the right-quarter window 30. The other upper corner portion 30b is close to but away from the right rear corner portion CP10 at which the right-quarter window-side edge of the roof panel 5A of the body frame B1 and the upper end of the right-quarter window-side edge of a right rear pillar 26a thereof meet.

The inner element portion 7 of the antenna element 2 is arranged along the center direction D10 of a corner angle formed by the right-quarter window-side edge of the roof panel 5A and the right-quater window-side edge of the right rear pillar 26a. The one end 7a of the inner element portion 7 is located at the right rear corner portion CP10. The feeding point 14 is electrically connected to the one end 7a of the inner element portion 7. The other end 7b of the inner element portion 7 is arranged on the center direction D10 of the corner angle. The connection element portion 10 is arranged to be parallel to the right-quarter window-side edge of the roof panel 5A, and the connection element portion 11 is arranged to be parallel to the right-quarter window-side edge of the right rear pillar 26a. Because other structures of the antenna element 2 of the mobile antenna 1j are substantially the same as those of the antenna element 2 of the mobile antenna 1, descriptions of which are omitted.

In addition, the mobile antenna 1k is symmetrically placed in the vehicle 3A with respect to the mobile antenna 1j in the lateral horizontal) direction of the vehicle 3A.

Specifically, the mobile antenna 1k is mounted at the other upper corner portion 31b of the inner surface of the left-quarter window 31. The other upper corner portion 31b is close to but away from the left rear corner portion CP11 at which the left-quarter window-side edge of the roof panel 5A of the body frame B1 and the upper end of the left-quarter window-side edge of a left rear pillar 27a thereof meet.

The inner element portion 7 of the antenna element 2 is arranged along the center direction D11 of a corner angle formed by the left-quarter window-side edge of the roof panel 5A and the left-quarter window-side edge of the left rear pillar 27a. The one end 7a of the inner element portion 7 is located at least adjacent to the left rear corner portion CP11. The feeding point 14 is electrically connected to the one end 7a of the inner element portion 7. The other end 7b of the inner element portion 7 is arranged on the center direction D11 of the corner angle. The connection element portion 10 is arranged to be parallel to the left-quarter window-side edge of the roof panel 5A, and the connection element portion 11 is arranged to be parallel to the left-quarter window-side edge of the left rear pillar 27a. Because other structures of the antenna element 2 of the mobile antenna 1k are substantially the same as those of the antenna element 2 of the mobile antenna 1, descriptions of which are omitted.

As described above, similar to the former described modifications, the antenna system AS6 according to the sixth modification of the first embodiment provides space diversity and different polarized surfaces because the mobile antennas 1h to 1k are symmetrically arranged on the upper-rear side of the vehicle 3A. This makes it possible to further improve the receiving efficiency of the vehicle 3 with respect to radio waves transmitted from both the front side and rear side of the vehicle 3A.

In the mobile antenna 1 according to the first embodiment set forth above, because the one end 7a of the inner element portion 7 is located at the upper-right corner portion CP, and the other end 7b thereof is arranged on the center direction D of the corner angle θ, the inner element portion 7 is arranged along the center direction D such that the inner element portion 2 thereof to be inclined to the vertical and horizontal directions with respect to the ground surface.

This structure of the mobile antenna 1 allows, as shown in FIGS. 2A and 2B, polarized surfaces C of the inner element portion 7 of the antenna element 2 to be non-orthogonal to each polarized surface A of each vertically polarized wave and each polarized surface B of each horizontally polarized wave in the radio waves. Specifically, the polarized surfaces C of the inner element portion 7 of the antenna element 2 are inclined with respect to each polarized surface A of each vertically polarized wave and each polarized surface B of each horizontally polarized wave in the radio waves.

This structure of the mobile antenna 1 allows vertically polarized waves and horizontally polarized waves to be effectively received when they are transmitted from the front side of the vehicle 3.

Moreover, when vertically polarized waves and horizontally polarized waves are transmitted from the rear side of the vehicle 3, the mobile antenna 1 permits the transmitted vertically polarized waves, which are diffracted by the roof panel 5 to enter into the interior of the vehicle 3, to be effectively received by the antenna element 2.

Furthermore, the mobile antenna 1 permits the transmitted horizontally polarized waves, which are diffracted by the right-side of the vehicle to enter into the interior thereof, to be effectively received by the antenna element 2.

That is, it is possible for the mobile antenna 1 according to the first embodiment to effectively receive both the vertically polarized waves and the horizontally polarized waves transmitted from both the front side of the vehicle and the rear side thereof. Consequently, the mobile antenna 1 is capable of stably receiving radio waves independently of any direction of the vehicle's travel and/or any direction from which the radio waves are transmitted.

In addition, in the mobile antenna 1, the other end 8a of the outer element portion 8 is electrically connected to the ground point 15 mounted on the roof panel 5 acting as ground. Similarly, the other end 9a of the outer element portion 9 is electrically connected to the ground point 16 mounted on the right front pillar 6 acting as ground.

Specifically, the inner element portion 7, the connection element portion 10, and the outer element portion 8 are configured to a folded monopole antenna in which the antenna current transmission line composed of the element portions 7, 10, and 8 is folded so that the other end portion 8a thereof is grounded to the roof antenna 5. Similarly, the inner element portion 7, the connection element portion 11, and the outer element portion 9 are configured to a folded monopole antenna in which the antenna current transmission line composed of the element portions 7, 11, and 9 is folded so that the other end portion 9a thereof is grounded to the right front pillar 6.

Each of the folded monopole antennas serves as a loop antenna. Specifically, the current component flowing through the loop (first loop) formed by the element portions 7, 10, and 8 allows detection of magnetic field components of the radio waves; the magnetic field components are directed to be orthogonal to the loop area. In addition, the current component flowing through the first loop allows detection of magnetic field formed by high-frequency currents flowing through the body frame B.

Similarly, the current component flowing through the loop (second loop) formed by the element portions 7, 11, and 9 allows detection of magnetic field components of the radio waves; the magnetic field components are directed to be orthogonal to the loop area. In addition, the current component flowing through the second loop allows detection of magnetic field formed by the high-frequency currents flowing through the body frame B.

Consequently, the mobile antenna 1 according to the first embodiment allows its sensitivity with respect to the radio waves to improve.

In addition, the loop areas formed by the antenna element 2 makes it possible for the mobile antenna 1 to improve the nondirectional characteristic thereof.

Furthermore, as illustrated in FIG. 1, the inner element portion 7, the connection element portion 10, the outer element portion 8, and the mesh portions 12 provide the plurality of current paths whose path lengths are different from each other. Similarly, the inner element portion 7, the connection element portion 11, the outer element portion 9, and the mesh portions 13 provide the plurality of current paths whose path lengths are different from each other.

These different path lengths (antenna lengths) provided by the antenna element 2 have corresponding different resonant frequencies, respectively; these different resonant frequencies correspond to a broad frequency band. Specifically, these different path lengths (antenna lengths) provided by the antenna element 2 allows the bandwidth of the mobile antenna 1 to be wider.

As illustrated in FIGS. 6 to 11, at least two of a plurality of the mobile antennas 1 and 1a to 1k can be mounted on the body frame B (B1) such that they are substantially symmetrically arranged in the space of the body frame B (B1). This structure provides space diversity that can achieve space diversity effect, making it possible to further improve the receiving efficiency of the vehicle 3 with respect to radio waves transmitted from both the front side and rear side of the vehicle 3.

In addition, at least two of a plurality of the mobile antennas 1 and 1a to 1k can be mounted on the body frame B (B1) such that directions in which antenna current components flow through the at least two antennas are different from each other. This structure can provide different polarized surfaces, making it possible to achieve polarization-diversity effect.

Note that, in the first embodiment, the inner element portion 7, and the outer element portions 8 and 9 are designed to have the same length L1 of 0.15λ, and the connection element portions 10 and 11 are designed to have the same length L2 of 0.2λ. In addition, the length L1 of 0.15λ and the length L2 of the 0.2λ are amended by multiplying them by the fractional shortening value within the range from 0.7 to 0.8.

The present invention is not limited to the lengths of the L1 and L2.

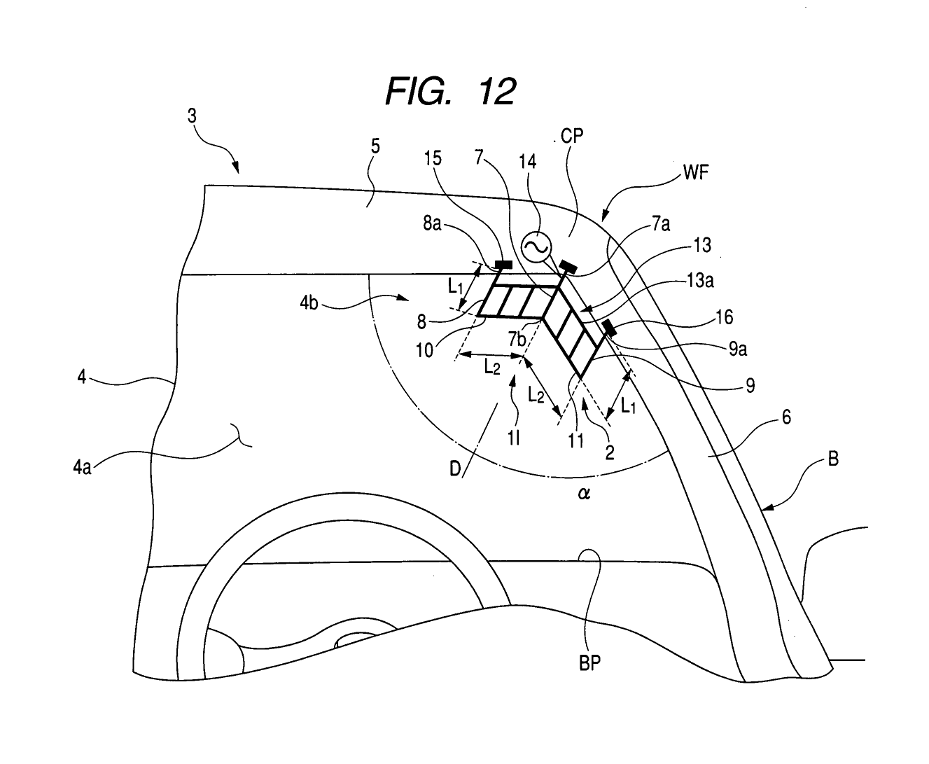

Specifically, FIG. 12 illustrates a mobile antenna 1l according to a still further modification of the first embodiment. In the mobile antenna 1, the lengths of the L1 and L2 can be desirably determined on condition that the overall length of each of the first loop (element portions 7, 10, and 8) and the second loop (element portions 7, 11, and 9), which is represented as “L1×2+L2”, becomes approximately

$$( \frac{1}{2} λ0 ) .$$

Note that λ0 is a wavelength corresponding to the lowest frequency within a target frequency range of, for example, 470 to 770 MHz of target radio waves, corresponding to UHF band.

Incidentally, when considering the influence of the fractional shortening value within the range from 0.7 to 0.8, each of the overall lengths of the first and second loops can be amended based on the fractional shortening value within the range from 0.7 to 0.8.

The structure of the mobile antenna 1l allows the overall length of each of the first and second loops to be set to approximately

$$( \frac{1}{2} λ0 ) \times the fractional shortening value within the range from 0.7 to 0.8 .$$

This allows loss caused by the impedance matching in each of the first and second loops of the mobile antenna 1l to decrease, making it possible to further improve the reception performance of the mobile antenna 1l.

The configuration of the antenna element 2 of the mobile antennas according to the first embodiment and its modifications is not limited to the above configuration illustrated in FIG. 1.

Specifically, as illustrated in FIG. 13A, an antenna element 41 of a mobile antenna 40 has a pair of bypass portions 43 and 44 in place of the mesh portions 12 and 13.

The bypass portion 43 is an electrically conductive linear member and is joined between an intermediate portion of the inner element portion 7 and that of the outer element portion 8. The bypass portion 43 is arranged to be substantially parallel to the front edge of the roof panel 5 with clearances therebetween.

The bypass portion 44 is an electrically conductive linear member and is joined between an intermediate portion of the inner element portion 7 and that of the outer element portion 9. The bypass portion 44 is arranged to be substantially parallel to the windshield-side edge of the right front pillar 6 with clearances therebetween.

Other elements of the mobile antenna 40 are substantially identical with those of the mobile antenna 1, so that the descriptions of which are omitted.

The configuration of the antenna element 41 of the mobile antenna 40 can provide a plurality of different current paths whose path lengths are different from each other, which is similar to the antenna element 2 of the first embodiment.

These different path lengths (antenna lengths) provided by the antenna element 41 allows the bandwidth of the mobile antenna 40 to be wider.

In addition, as illustrated in FIG. 13B, an antenna element 51 of a mobile antenna 50 has no mesh portions 12 and 13, and bypass portions 43 and 44, as compared with the configurations of the antenna element 2 and the antenna element 41. Because the mobile antenna 50 has a more simple structure than the structures of the mobile antennas 2 and 40, it is useful in cases where there is no need for wider bandwidth of the mobile antenna 50.

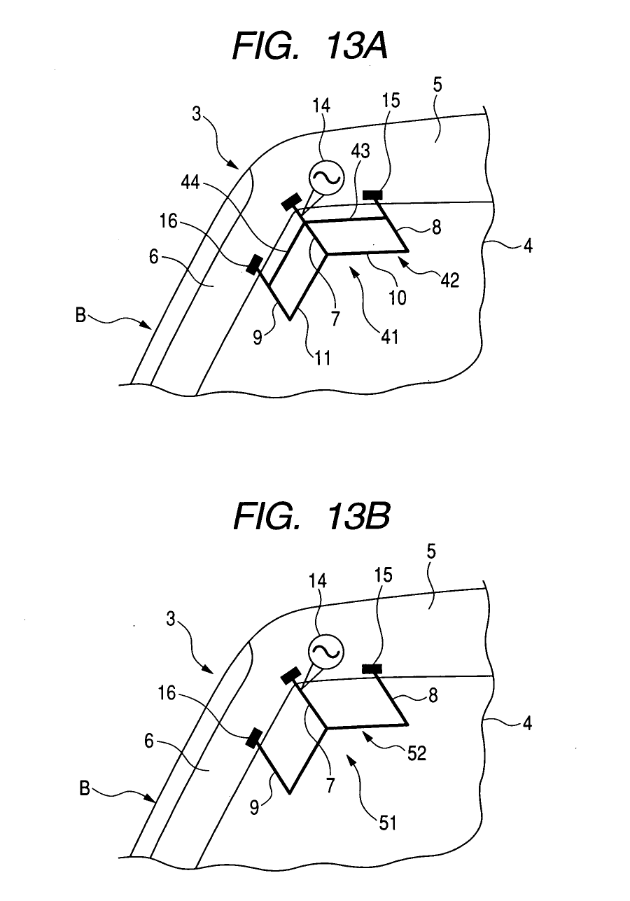

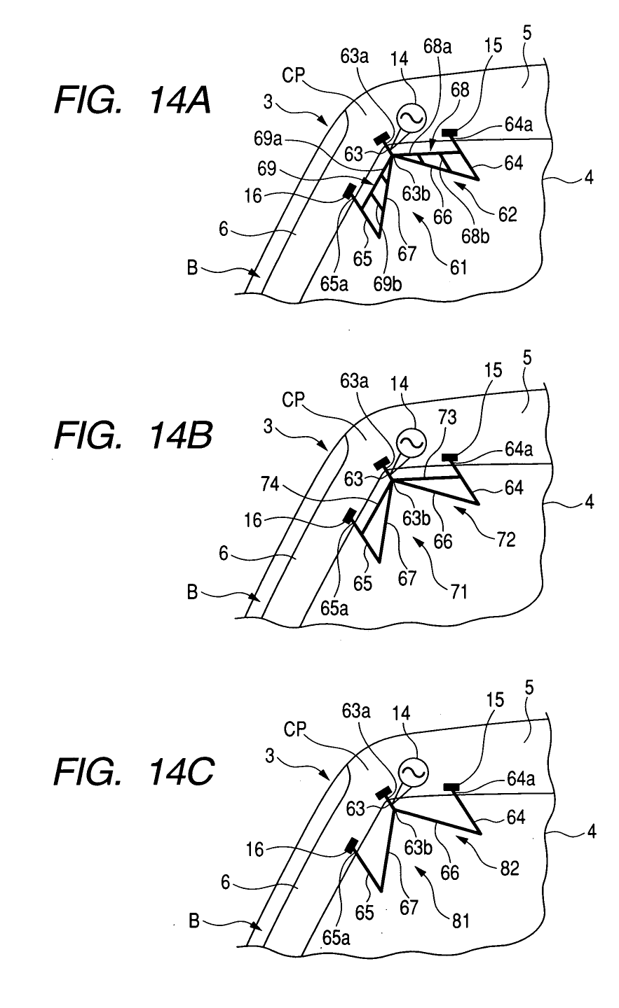

FIG. 14A illustrates a configuration of an antenna element 61 of a mobile antenna 60; this configuration of the antenna element 61 is a modification of the antenna element 2.

The antenna element 61 has a linear inner element portion 63, a pair of linear outer element portions 64 and 65, and a pair of linear connection element portions 66 and 67.

The inner element portion 63 has one end 63a and the other end 63b. The inner element portion 63 is arranged along the center direction of a corner angle formed by the front edge of the roof panel 5 and the windshield-side edge of the right front pillar 6, which is similar to the antenna element 2. The one end 63a of the inner element portion 63 is located at least adjacent to the upper-right corner portion CP. A feeding point 14 is electrically connected to the one end 63a of the inner element portion 63. The other end 63b of the inner element portion 63 is arranged on the center direction of the corner angle, which is similar to the antenna element 2.

The outer element portions 64 and 65 are arranged to be parallel to the inner element portion 63, respectively, and configured such that the length of each of the outer element portions 64 and 65 is longer than that of the inner element portion 63.

One end of each of the connection element portions 66 and 67 is joined to the other end 63b of the inner element portion 63. The connection element portion 66 is arranged to be parallel to the front edge of the roof panel 5, and the other end of the connection electric portion 66 is joined to one end of the outer element portion 64. The connection element portion 67 is arranged to be parallel to the windshield-side edge of the right front pillar 6, and the other end of the connection element portion 67 is joined to one end of the outer element portion 65.

The other end 64a of the outer element portion 64 extends onto the front edge of the roof panel 5 so as to be electrically connected to the ground point 15. Similarly, the other end portion 65a of the outer element portion 65 extends onto the right front pillar 6 so as to be electrically connected to the ground point 16.

Furthermore, the antenna element 62 has a pair of mesh portions 68 and 69.

The mesh portion 68 is composed of a linear element portion 68a arranged, for example, to be substantially parallel to the front edge of the roof panel 5 with clearances therebetween. The linear element portion 68a is joined between the other end 63b of the inner element portion 63 and an intermediate portion of the outer element portion 64.

The mesh portion 68 is also composed of a plurality of, such as two, bars 68b. The bars 68b are joined between the connection element portion 66 and the linear element portion 68a to be parallel to the outer element portion 64 such that they have intervals along the linear element portion 68a. Specifically, as illustrated in FIG. 14A, the inner element portion 63, the connection element portion 66, the outer element portion 64, the linear element portion 68a, and the bars 68b provide a plurality of current paths.

Similarly, the mesh portion 69 is composed of a linear element portion 69a arranged, for example, to be substantially parallel to the windshield-side edge of the right front pillar 6 with clearances therebetween.

The linear element portion 69a is joined between the other end 63b of the inner element portion 63 and an intermediate portion of the outer element portion 65.

In addition, the mesh portion 69 is also composed of a plurality of, such as two, bars 69b. The bars 69b are joined between the connection element portion 67 and the linear element portion 69a to be parallel to the outer element portion 65 such that they have regular intervals along the connection element portion 11 (linear element portion 13a). Specifically, as illustrated in FIG. 14A, the inner element portion 63, the connection element portion 67, the outer element portion 65, the linear element portion 69a, and the bars 69b provide a plurality of current paths (loops).

Other elements of the mobile antenna 61 are substantially identical with those of the mobile antenna 1, so that the descriptions of which are omitted.

In addition, as illustrated in FIG. 14D, an antenna element 72 of a mobile antenna 71 can be provided with a pair of bypass portions 73 and 74 in place of the mesh portions 68 and 69 of the antenna element 62.

The bypass portion 73 is an electrically conductive linear member and is joined between the other end 63b of the inner element portion 63 and an intermediate portion of the outer element portion 64. The bypass portion 73 is arranged to be substantially parallel to the front edge of the roof panel 5 with clearances therebetween.

The bypass portion 74 is an electrically conductive linear member and is joined between the other end 63b of the inner element portion 63 and an intermediate portion of the outer element portion 65. The bypass portion 74 is arranged to be substantially parallel to the windshield-side edge of the right front pillar 6 with clearances therebetween. Other elements of the mobile antenna 71 are substantially identical with those of the mobile antenna 61, so that the descriptions of which are omitted.

Moreover, as illustrated in FIG. 14C, an antenna element 82 of a mobile antenna 81 can be provided with no mesh portions 68 and 69, and bypass portions 64 and 65, as compared with the configurations of the antenna element 62 and the antenna element 72. Other elements of the mobile antenna 81 are substantially identical with those of the mobile antenna 61, so that the descriptions of which are omitted.

For example, FIG. 3B illustrates the measurement result of horizontal-plane directional patterns of the mobile antenna 51 in which the length of each of the outer element portions 64 and 65 is set to approximately 0.2λ×the fractional shortening value of 0.75, and the length of each of the connection element portions 66 and 67 is set to approximately 0.3λ×the fractional shortening value of 0.75.

As illustrated in FIG. 3B, in the mobile antenna 51, high directional gains are obtained to not only the front windshield side (the front side of the vehicle 3) to which the mobile antenna 51 is mounted, but also to the opposite side (the rear side of the vehicle 3). That is, the mobile antenna 51 according to the modification of the first embodiment can provide good and hardly-biased directional gains.

In addition, in the mobile antenna 51, loss resistance of the antenna element 52 is smaller than that of the antenna element 17a, and receiving efficiency of the antenna element 52 is higher than that of the antenna element 17a. These characteristics cause an average gain of the mobile antenna 51 with respect to the vertically-polarized waves to become −10.6 dB, which is more improved than an average gain of −17.5 dB of the mobile antenna 17 with respect to vertically-polarized waves. Similarly, these characteristics cause an average gain of the mobile antenna 51 with respect to the horizontally-polarized waves to become −8.3 dB, which is more improved than an average gain of −16.4 dB of the mobile antenna 17 with respect to horizontally-polarized waves.

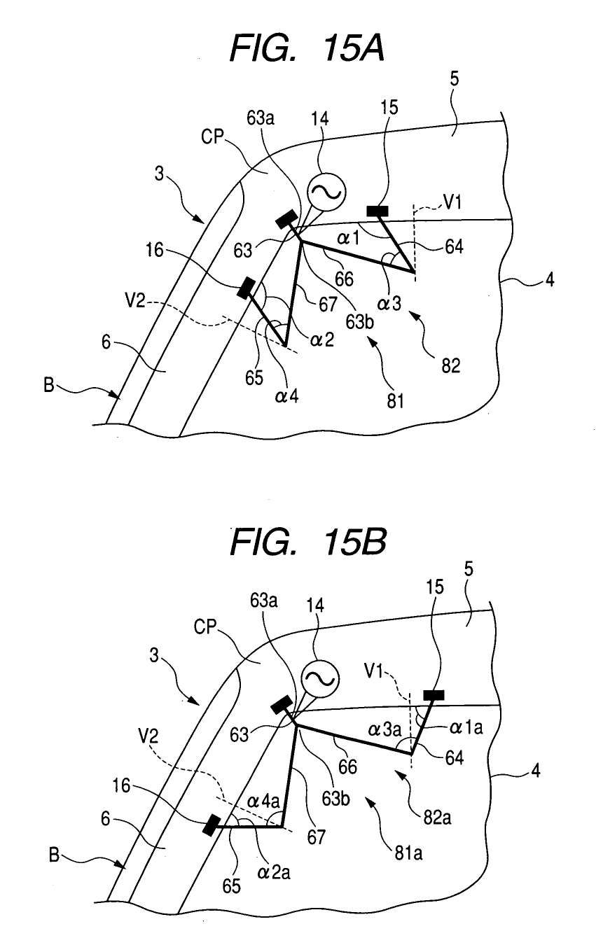

In the configuration of the mobile antenna 81 illustrated in FIG. 14C, as illustrated in FIG. 15A, the antenna element 82 of the mobile antenna 81 is configured such that the ground point 15 is arranged between the inner element portion 63 and a vertical line v1 orthogonal to the front edge of the roof panel 5. In other words, a ground angle α1 formed by the front edge of the roof panel 5 and the outer element portion 64 is set to a right angle or an obtuse angle (≧90 degrees), and a folded angle α3 formed by the outer element portion 64 and the connection element portion 66 is set to an acute angle (<90 degrees).

Similarly, the antenna element 82 of the mobile antenna 81 is configured such that the ground point 16 is arranged between the inner element portion 63 and a vertical line v2 orthogonal to the windshield-side edge of a right front pillar 6. In other words, a ground angle α2 formed by the windshield-side edge of a right front pillar 6 and the outer element portion 65 is set to a right angle or an obtuse angle (≧90 degrees), and a folded angle α4 formed by the outer element portion 65 and the connection element portion 67 is set to an acute angle (<90 degrees).

In the configuration of the mobile antenna 81 illustrated in FIG. 15A, the ground angle α1 of the outer element portion 64 with respect to the front edge of the roof panel 5 is an angle that allows capacity coupling to occur between the outer element portion 64 and the front edge of the roof panel 5. In addition, the folded angle α3 of the connection element portion 66 and the outer element portion 64 is an angle that allows capacity coupling to occur therebetween.

Similarly, the ground angle α2 of the outer element portion 65 with respect to the windshield-side edge of the right front pillar 6 is an angle that allows capacity coupling to occur between the outer element portion 65 and the windshield-side edge of the right front pillar 6. In addition, the folded angle α4 of the connection element portion 67 and the outer element portion 65 is an angle that allows capacity coupling to occur therebetween.

In the configuration of the antenna eminent 82 of the mobile antenna 81, the capacity coupling can obtain the effects obtained in the antenna element 62 or antenna element 72 to which the mesh portions or the bypass portions are provided, making it possible to wide the bandwidth of the mobile antenna 81.

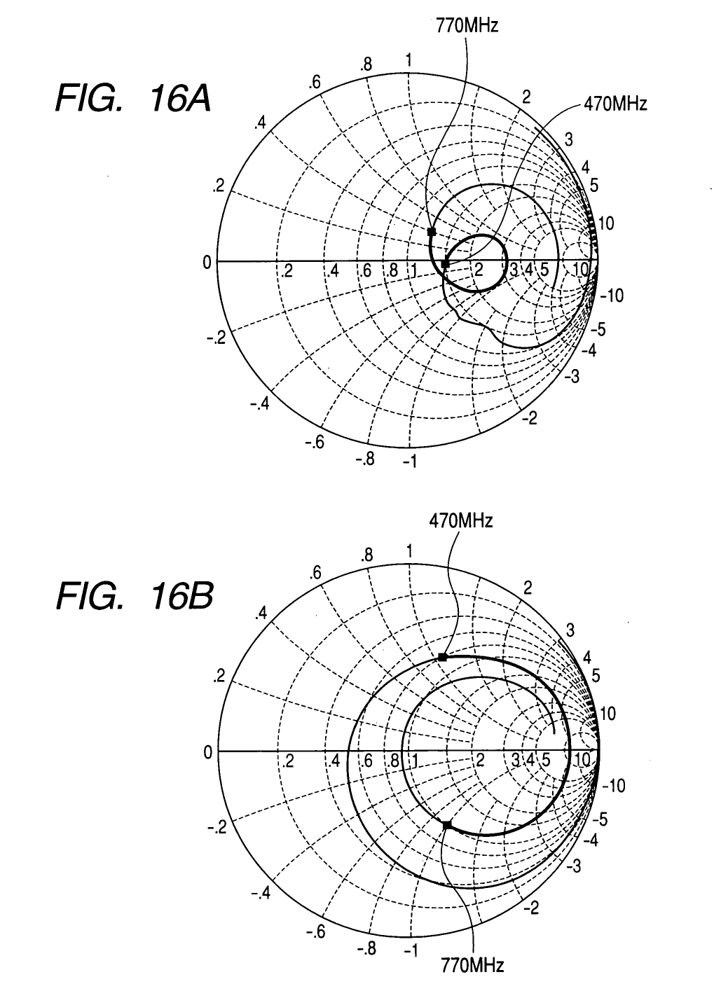

Incidentally, FIG. 16 illustrates the measurement result of impedance variation range with respect to the ground angle of the outer element portion 64 with respect to the front edge of the roof panel 5 and the ground angle of the outer element portion 65 with respect to the windshield-side edge of the right front pillar 6.

In this case, when the ground angle α1 of the outer element portion 64 with respect to the front edge of the roof panel 5 is set to an obtuse angle, and the ground angle α2 of the outer element portion 65 with respect to the windshield-side edge of the right front pillar 6 is set to an obtuse angle (see FIG. 15A), as illustrated in FIG. 16A, the impedance variation range is approximately 98 Ω within the target radio wave's frequency range of 470 to 770 MHz corresponding to UHF band. Because the impedance variation range of 98 Ω is comparatively small, the mobile antenna 81 with a wide bandwidth can be obtained.

In contrast, as illustrated as an antenna element 82a of a mobile antenna 81a in FIG. 15B, it is assumed that the ground angle α1a of the outer element portion 64 with respect to the front edge of the roof panel 5 is set to an acute angle (the folded angle α3a is an obtuse angle). In addition, in the antenna element 82a of the mobile antenna 81a, it is assumed that the ground angle α2a of the outer element portion 65 with respect to the windshield-side edge of the right front pillar 6 is set to an acute angle (the folded angle α4a is an obtuse angle). In the mobile antenna 81a, as illustrated in FIG. 16B, the impedance variation range is approximately 473 Ω within the target radio wave's frequency range of 470 to 770 MHz. Because the impedance variation range of 473 Ω is comparatively large, it is difficult for the mobile antenna 81a to obtain a wide bandwidth.

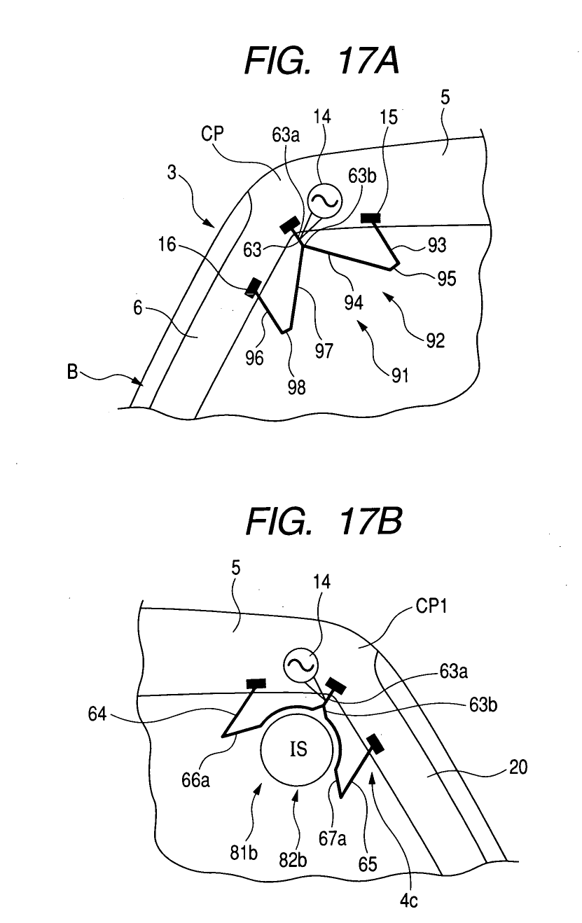

As illustrated in FIG. 17A, as a modification of the configuration of the mobile antenna 81, a mobile antenna 91 has an antenna element 92, which has substantially identical structure of the mobile antenna element 62 of the mobile antenna 61. Specifically, outer element portions 93 and 96 correspond to the outer element portions 64 and 65, respectively, and connection element portions 94 and 97 correspond to the connection element portions 66 and 67, respectively.

Specifically, the antenna element 92 of the mobile antenna 91 is configured such that capacity coupling occurs between the connection element portion 94 and the outer element portion 93, and between the connection element portion 97 and the outer element portion 96, which is similar to the antenna element 82.

In addition, the antenna element 92 is provided with a fold connection portion 95 connecting between the other end of the connection element portion 94 and the one end of the outer element portion 93. The antenna element 92 is also provided with a fold connection portion 98 connecting between the other end of the connection element portion 97 and the one end of the outer element portion 96.

Moreover, as illustrated in FIG. 17B, it is assumed that a mobile antenna 81b, which is a modification of the mobile antenna 81, is mounted at the upper-left corner portion 4c of the inner surface 4a of the front windshield 4. Because a circular motor vehicle inspection sticker, referred to as “IS” has been already adhered on the upper-left corner portion 4c of the inner surface 4a of the front windshield 4, the mobile antenna 81b is mounted at the upper-left corner portion 4c of the inner surface 4a of the front windshield 4 such that connection element portions 66a and 67a surround the motor vehicle inspection sticker.

Specifically, each of the connection element portions 66a and 67a is partly curved around the outer circumference of the sticker to prevent the connection element portions 66a and 67a from being overlapped on the sticker.

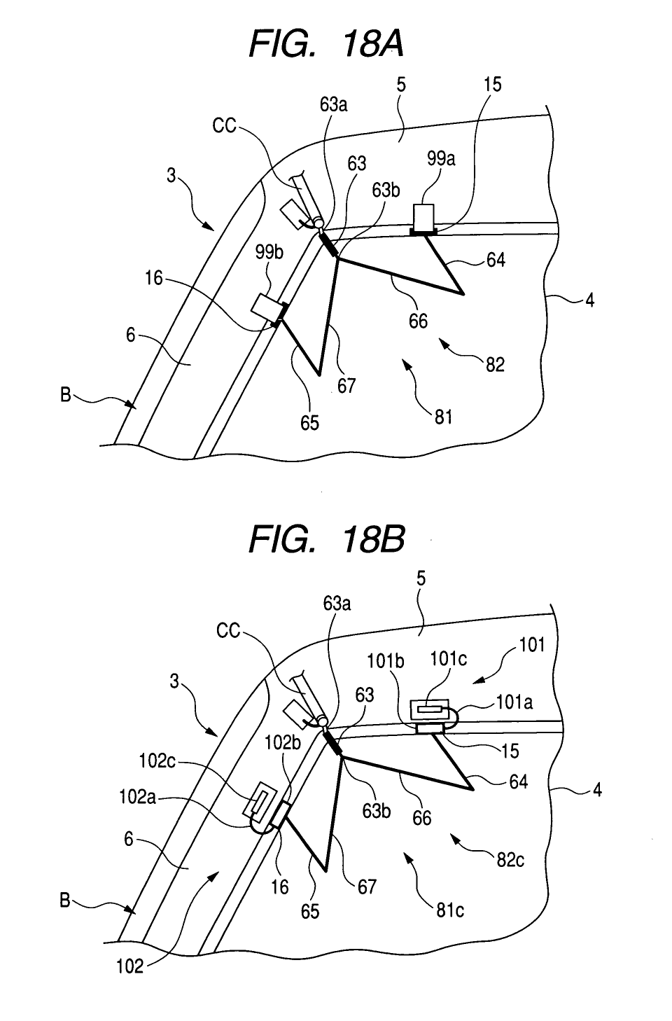

As illustrated in FIG. 18A, as an example of mount structures of the ground points 15 and 16, the ground point 15 can be mounted on the inner surface of the front edge of the roof panel 5 through a beaten copper tape 99a. In addition, the ground point 16 can be mounted on the inner surface of the windshield-side edge of the right front pillar 6 through a beaten copper tape 99b. Moreover, as the feeder 14, a coaxial cable CC is electrically connected to the one end 63a of the inner element portion 63 of the antenna element 82.

As a comparative example, as illustrated in FIG. 18B, the ground point 15 is mounted on the inner surface of the front edge of the roof panel 5 through ground terminal 101, and the ground point 16 is mounted on the inner surface of the windshield-side edge of the right front pillar 6 through a ground terminal 102. The ground terminal 101 is provided with an AV (Audio-Video) line 101a, a connector 101b electrically connected to the ground point 15 so that one end of the AV line 101a is electrically connected to the connector 10b. The ground terminal 101 is also provided with a connector 101c electrically connected to the other end of the AV line 101a.

Similarly, the ground terminal 102 is provided with an AV (Audio-Video) line 102a, a connector 102b electrically connected to the ground point 16 so that one end of the AV line 102a is electrically connected to the connector 102b. The ground terminal 102 is also provided with a connector 102c electrically connected to the other end of the AV line 102a.

As a result of comparing with the mount structures of the ground points 15 and 16 illustrated in FIG. 18B, the mount structures of the ground points 15 and 16 illustrated in FIG. 18A allow the ground terminals 101 and 102 to be eliminated, making it possible to prevent loss resistance from increasing and the mobile antenna's gain from decreasing. In addition, it is possible to reduce the cost of mounting the mobile antenna 81 on the vehicle 3.

### Second Embodiment

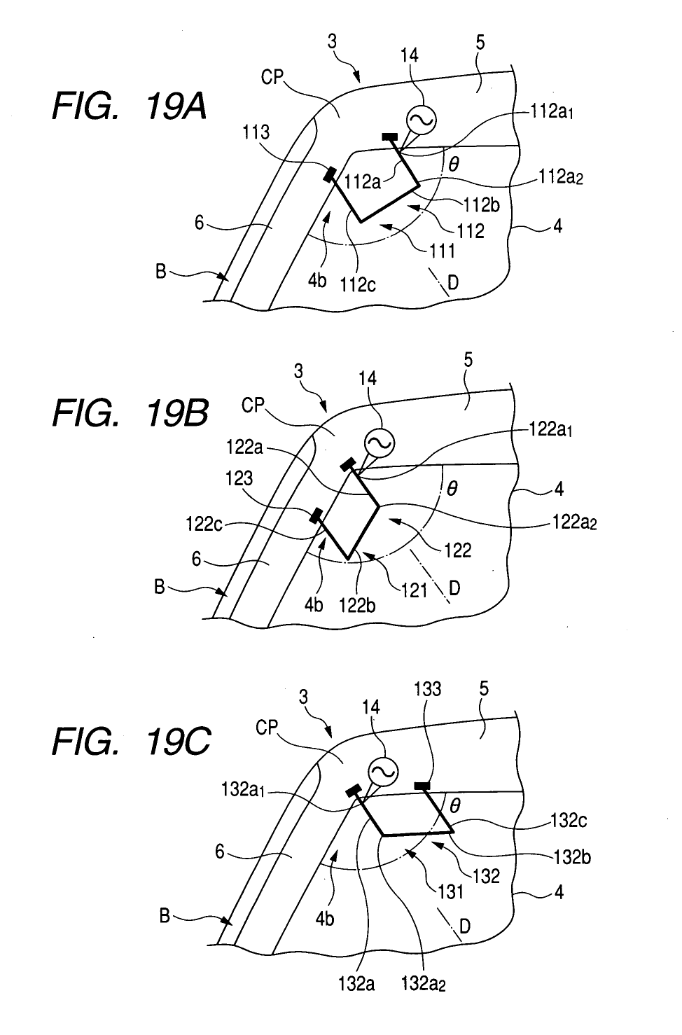

A second embodiment of the present invention will be described with reference to FIGS. 19 to 21. Note that descriptions of elements related to the second embodiment, which are substantially the same as those related to the first embodiment, are omitted so that remaining elements related to the second embodiment, which are different from the remaining elements related to the first embodiment, will be described.

FIG. 19A schematically illustrates a mobile antenna 111 according to a second embodiment of the present invention, which is mounted on the body frame B of the vehicle 3.

The mobile antenna 111 is provided with an antenna element 112 formed in a loop. The antenna element 112 is located at, for example, the upper-right corner portion 4b of the inner surface 4a of the front windshield 4.

The antenna element 112 has a first linear element portion 112a, a second linear element portion 112b, and a third linear element portion 112c.

The first linear element portion 112a has one end 112a1 and the other end 112a2. The first linear element portion 112a is arranged parallel to the center direction D of the corner angle θ formed by the front edge of the roof panel 5 and the windshield-side edge of the right front pillar 6. A feeding point (feeder) 14 is electrically connected to the one end 112a1 of the first linear element portion 112a such that power is fed to the antenna element 112 through the feeding point 14.

One end of the second linear antenna element 112b is joined to the other end 112a2 of the first linear element portion 112a such that the second linear element portion 112b is arranged to be orthogonal to the first linear element portion 112a. The other end of the second linear element portion 112b is joined to one end of the third linear element portion 112c. The third linear element portion 112c is arranged to be parallel to the first linear element portion 112a. The other end of the third linear element portion 112c extends onto the windshield-side edge of the right front pillar 6 to be electrically connected to a ground point 113. The ground point 113 is mounted on the inner surface of the windshield-side edge of the right front pillar 6 so as to be grounded thereto.

The overall length of the antenna element 112 is designed to 0.5λ

$$( \frac{λ}{2} ) \times the fractional shortening value within the range from 0.7 to 0.8 ;$$

this λ is a wavelength of target radio waves.

In the structure of the mobile antenna 111, when power fed to the antenna element 112 through the feeding point 14 allows an antenna current to flow through the first linear antenna element 112a from the feeding point 14.

The first linear element portion 112a is arranged parallel to the center direction D of the corner angle θ, so that it is inclined to the vertical and horizontal directions with respect to the ground surface.

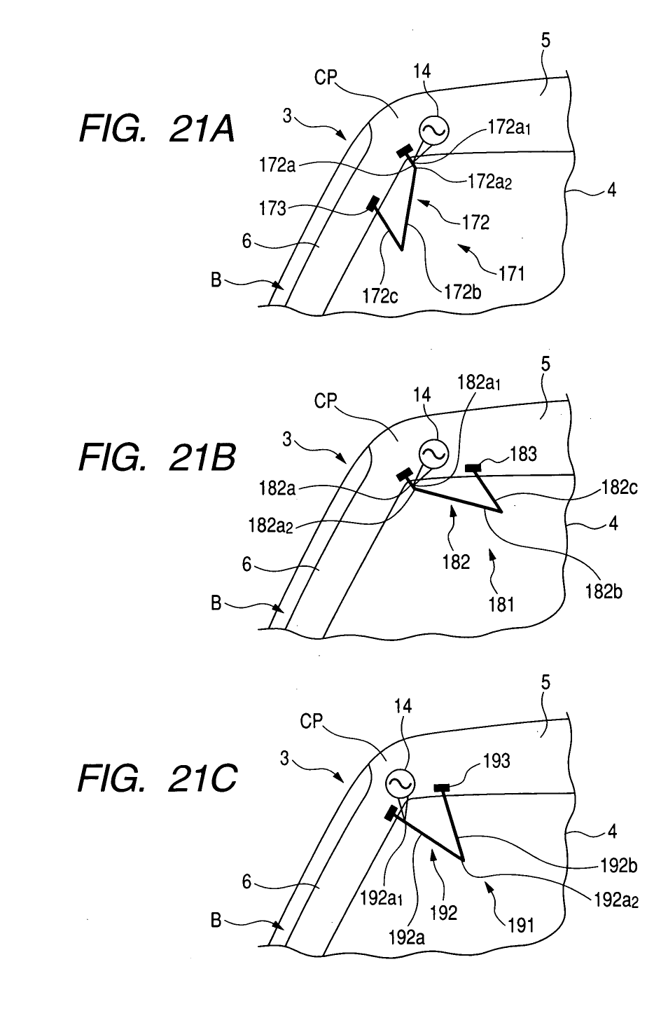

This structure allows, as shown in FIGS. 2A and 21, polarized surfaces C of the first linear element portion 112a of the antenna element 112 to be non-orthogonal to each polarized surface A of each vertically polarized wave and each polarized surface B of each horizontally polarized wave in the radio waves, which is similar to the antenna element 2 according to the first embodiment.

Specifically, the mobile antenna 111 can effectively receive vertically and horizontally polarized waves when they are transmitted from the front side of the vehicle 3.

Furthermore, when vertically and horizontally polarized waves are transmitted from the rear side of the vehicle 3, the mobile antenna 111 permits the transmitted vertically polarized waves, which are diffracted by the roof panel 5 to enter into the interior of the vehicle 3, to be effectively received by the antenna element 112. This is because the antenna element 112 is arranged close to the roof panel 5 of the vehicle and each polarized surface C of the first linear element portion 112a of the antenna element 112 is not to be orthogonal but to be crossed, at approximately 45 degrees, to each of the polarized surfaces A of he vertically polarized waves.

In addition, the mobile antenna 111 permits the transmitted horizontally polarized waves, which are diffracted by the right-side of the vehicle to enter into the interior thereof, to be effectively received by the antenna element 112. This is because the antenna element 112 is arranged close to the right-side of the vehicle and each polarized surface of the first linear element portion 112a of the antenna element 112 is not to be orthogonal but to be crossed, at approximately 45 degrees, to each of the polarized surfaces B of the horizontally polarized waves.

That is, it is possible for the mobile antenna 111 according to the second embodiment to effectively receive both the vertically polarized waves and the horizontally polarized waves transmitted from both the front side of the vehicle and the rear side thereof.

Moreover, the antenna current passing through the first linear element portion 112a flows through the second linear element portion 112b and the third linear element portion 112c into the ground point 13 in loop.

The current flowing through the loop formed by the antenna element 112 allows detection of magnetic field components of the radio waves; the magnetic field components are directed to be orthogonal to the loop area. In addition, the current flowing through the loop formed antenna element 112 allows detection of magnetic field formed by high-frequency currents flowing through the body frame B.

As described above, the mobile antenna 111 allows radio waves to be stably received independently of any direction of the vehicle's travel and/or any direction from which the radio waves are transmitted.

In addition, in the mobile antenna 111, the other end of the third linear element portion 112c is folded to be electrically connected to the ground point 113 mounted on the right front pillar 6 acting as ground.

Specifically, the antenna element 112 is configured to a folded monopole antenna in which the antenna current transmission line composed of the antenna element 112 is folded so that the other end portion of the third linear element portion 112c is grounded to the right front pillar 6.

The folded monopole antenna serves as a loop antenna. Specifically, the current flowing through the loop formed by the antenna element 112 allows detection of magnetic field components of the radio waves; the magnetic field components are directed to be orthogonal to the loop area. This makes it possible to improve the sensitivity of the mobile antenna 111 with respect to the radio waves.

A modification of the mobile antenna 111 according to the second embodiment is illustrated in FIG. 19B. As shown in FIG. 19B, a mobile antenna 121 according to the modification is provided with an antenna element 122 formed in a loop. The antenna element 122 is located at, for example, the upper-right corner portion 4b of the inner surface 4a of the front windshield 4.

The antenna element 122 has a first linear element portion 122a, a second linear element portion 122b, and a third linear element portion 122c.

The first linear element portion 122a has one end 122a1 and the other end 122a2. The first linear element portion 122a is arranged along the center direction D of the corner angle θ formed by the front edge of the roof panel 5 and the windshield-side edge of the right front pillar 6. A feeding point (feeder) 14 is electrically connected to the one end 122a1 of the first linear element portion 122a such that power is fed to the antenna element 122 through the feeding point 14.

One end of the second linear antenna element 122b is joined to the other end 122a2 of the first linear element portion 122a such that the second linear element portion 122b is arranged to be parallel to the windshield-side edge of the right front pillar 6. The other end of the second linear element portion 122b is joined to one end of the third linear element portion 122c. The third linear element portion 122c is arranged to be parallel to the first linear element portion 122a. The other end of the third linear element portion 122c extends onto the windshield-side edge of the right front pillar 6 to be electrically connected to a ground point 123. The ground point 123 is mounted on the inner surface of the windshield-side edge of the right front pillar 6 so as to be grounded thereto.

This configuration of the mobile antenna 121 can obtain substantially the same effects obtained by the mobile antenna 111.

In addition, another modification of the mobile antenna 11 according to the second embodiment is illustrated in FIG. 19C. As shown in FIG. 19C, a mobile antenna 131 according to another modification is provided with an antenna element 132 formed in a loop. The antenna element 132 is located at, for example, the upper-right corner portion 4b of the inner surface 4a of the front windshield 4.

The antenna element 132 has a first linear element portion 132a, a second linear element portion 132b, and a third linear element portion 132c.

The first linear element portion 132a has one end 132a1 and the other end 132a2. The first linear element portion 132a is arranged along the center direction D of the corner angle θ formed by the front edge of the roof panel 5 and the windshield-side edge of the right front pillar 6. A feeding point (feeder) 14 is electrically connected to the one end 132a1 of the first linear element portion 132a such that power is fed to the antenna element 122 through the feeding point 14.

One end of the second linear antenna element 132b is joined to the other end 132a2 of the first linear element portion 132a such that the second linear element portion 132b is arranged to be parallel to the front edge of the roof panel 5. The other end of the second linear element portion 132b is joined to one end of the third linear element portion 132c. The third linear element portion 132c is arranged to be parallel to the first linear element portion 132a. The other end of the third linear element portion 132c extends onto the front edge of the roof panel 5 to be electrically connected to a ground point 133. The ground point 133 is mounted on the inner surface of the front edge of the roof panel 5 so as to be grounded thereto.

This configuration of the mobile antenna 131 can obtain substantially the same effects obtained by the mobile antenna 111.

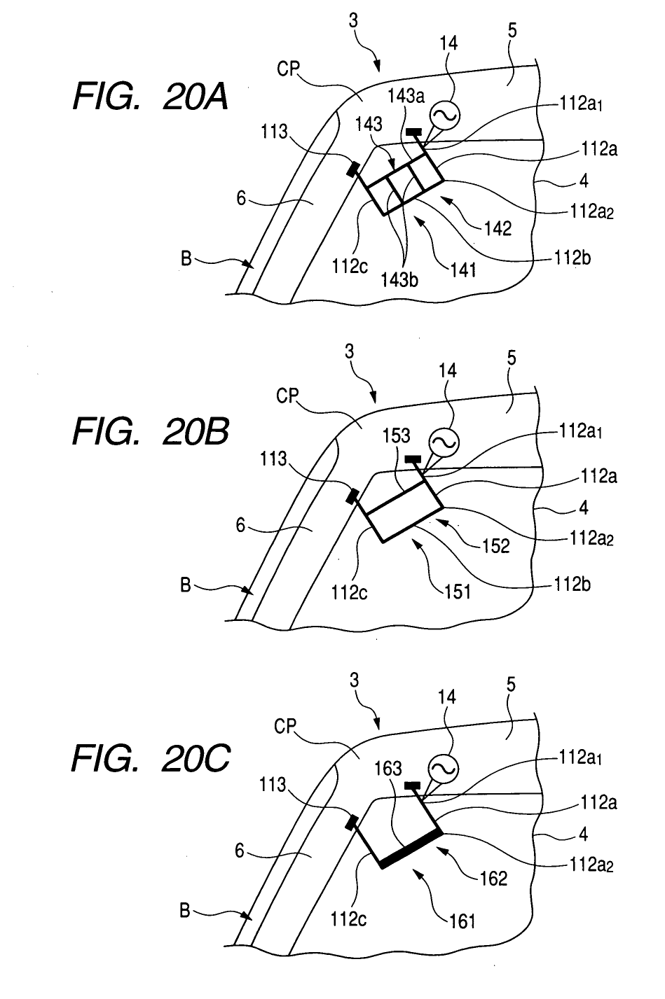

FIG. 20A illustrates a configuration of an antenna element 142 of a mobile antenna 141; this configuration of the antenna element 142 is a modification of the antenna element 112.

Specifically, the antenna element 142 is provided with the first to third linear element portions 112a to 112c.

In addition, the antenna element 142 has a mesh portion 143.

The mesh portion 143 is composed of a linear element portion 143a arranged, for example, to be substantially parallel to the second linear element portion 112b. The linear element portion 143a is joined between an intermediate portion of the first linear element portion 112a and that of the third linear element portion 112c.

The mesh portion 143 is also composed of a plurality of, such as two, bars 143b. The bars 143b are joined between the second linear element portion 112 b and the linear element portion 143a to be parallel to the first linear element portion 112a such that they have intervals along the linear element portion 143a. Specifically, as illustrated in FIG. 20A, the first to third linear element portions 112a to 112c, the linear element portion 143a, and the bars 143b can provide a plurality of current paths.

In addition, as illustrated in FIG. 20B, an antenna element 152 of a mobile antenna 151 can be provided with a bypass portion 153 in place of the mesh portion 143 of the antenna element 142.

The bypass portion 153 is arranged, for example, to be substantially parallel to the second linear element portion 112b. The bypass portion 153 is joined between an intermediate portion of the first linear element portion 112a and that of the third linear element portion 112c.

The first to third linear element portions 112a to 112c and the bypass portion 153 can provide a plurality of current paths whose path lengths are different from each other.

Moreover, as illustrated in FIG. 20C, an antenna element 162 of a mobile antenna 161 can be provided with a wide connection bar 163 in place of the second linear element portion 112b of the antenna element 112.

The wide connection bar 163 has a width wider than that of each of the first and third linear element portions 112a and 112c.

One end of the wide connection bar 163 is joined to the other end 112a2 of the first linear element portion 112a such that the wide connection bar 163 is arranged to be orthogonal to the first linear element portion 112a. The other end of the wide connection bar 163 is joined to one end of the third linear element portion 112c.

The first and third linear element portions 112a and 112c and the wide connection bar 163 can provide a plurality of current paths whose path lengths are different from each other.

These different path lengths (antenna lengths) provided by the antenna elements 142, 152, and 162 allow wideband radio waves to be effectively received, respectively.

FIG. 21A schematically illustrates a mobile antenna 171 according to a further modification of the second embodiment.

The mobile antenna 171 is provided with an antenna element 172 formed in a loop. The antenna element 172 is located at, for example, the upper-right corner portion 4b of the inner surface 4a of the front windshield 4.

The antenna element 172 has a first linear element portion 172a, a second linear element portion 172b, and a third linear element portion 172c.

The first linear element portion 172a has one end 172a1 and the other end 172a2. The one end 172a1 of the first linear element portion 172a is arranged at least adjacent to the corner portion CP. The first linear element portion 172a is arranged along the center direction of the corner angle formed by the front edge of the roof panel 5 and the windshield-side edge of the right front pillar 6. A feeding point (feeder) 14 is electrically connected to the one end 172a1 of the first linear element portion 172a such that power is fed to the antenna element 172 through the feeding point 14.

The length of the third linear element portion 172c is longer than that of the first linear element portion 172a. One end of the second linear antenna element 172b is joined to the other end 172a2 of the first linear element portion 172a. The other end of the second linear element portion 172b is joined to one end of the third linear element portion 172c. The third linear element portion 172c is arranged to be parallel to the first linear element portion 172a. The other end of the third linear element portion 172c extends onto the windshield-side edge of the right front pillar 6 to be electrically connected to a ground point 173. The ground point 173 is mounted on the inner surface of the windshield-side edge of the right front pillar 6 so as to be grounded thereto.

A still further modification of the mobile antenna 111 according to the second embodiment is illustrated in FIG. 21B. As shown in FIG. 21B, a mobile antenna 181 is provided with an antenna element 182 formed in a loop.

The antenna element 182 has a first linear element portion 182a, a second linear element portion 182b, and a third linear element portion 182c.

The first linear element portion 182a has one end 182a1 and the other end 182a2. The one end 182a1 of the first linear element portion 182a is arranged at least adjacent to the corner portion CP. The first linear element portion 182a is arranged along the center direction of the corner angle formed by the front edge of the roof panel 5 and the windshield-side edge of the right front pillar 6. A feeding point (feeder) 14 is electrically connected to the one end 182a1 of the first linear element portion 182a such that power is fed to the antenna element 182 through the feeding point 14.

The length of the third linear element portion 182c is longer than that of the first linear element portion 182a. One end of the second linear antenna element 182b is joined to the other end 182a2 of the first linear element portion 182a. The other end of the second linear element portion 182b is joined to one end of the third linear element portion 182c. The third linear element portion 182c is arranged to be parallel to the first linear element portion 182a. The other end of the third linear element portion 182c extends onto the front edge of the roof panel 5 to be electrically connected to a ground point 183. The ground point 183 is mounted on the inner surface of the front edge of the roof panel 5 so as to be grounded thereto.

A still further modification of the mobile antenna 111 according to the second embodiment is illustrated in FIG. 21C. As shown in FIG. 21C, a mobile antenna 191 is provided with an antenna element 192 formed in a loop.

The antenna element 192 has a first linear element portion 192a and a second linear element portion 192b.

The first linear element portion 192a has one end 192a1 and the other end 192a2. The one end 192a1 of the first linear element portion 192a is mounted on the windshield-side edge of the right front pillar 6. The first linear element portion 192a is arranged to be directed toward the center of the front windshield 4. A feeding point (feeder) 14 is electrically connected to the one end 192a1 of the first linear element portion 192a such that power is fed to the antenna element 192 through the feeding point 14. One end of the second linear antenna element 192b is joined to the other end 192a2 of the fist linear element portion 192a. The other end of the second linear element portion 192b extends onto the front edge of the roof panel 5 to be electrically connected to a ground point 193. The ground point 193 is mounted on the inner surface of the front edge of the roof panel 5 so as to be grounded thereto.

### Third Embodiment

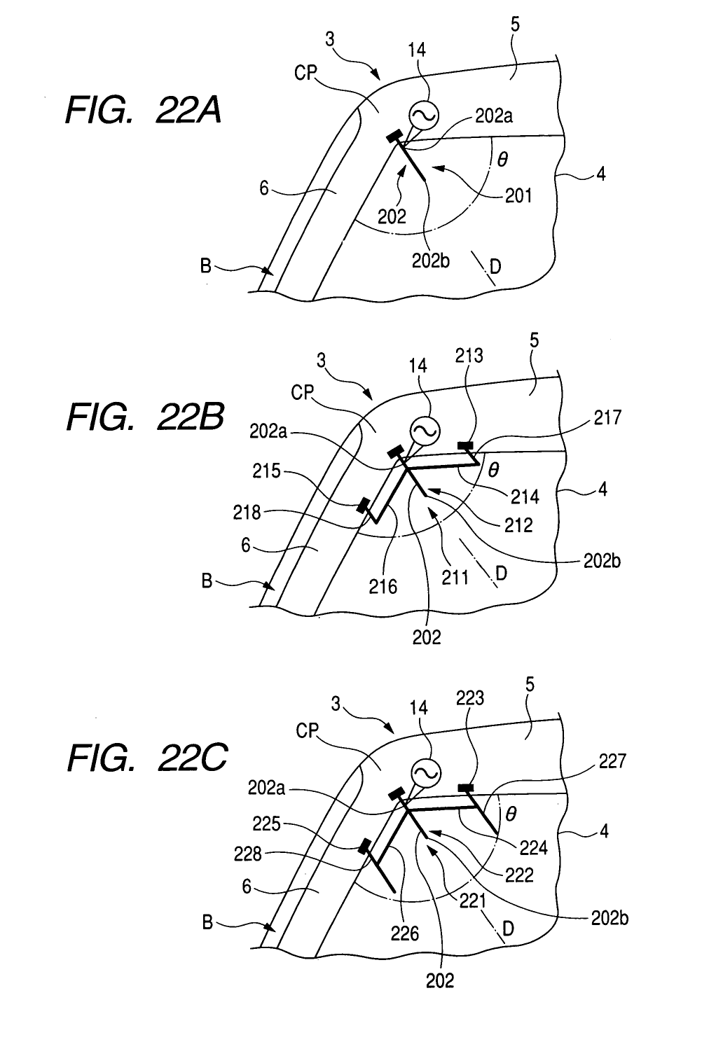

A third embodiment of the present invention will be described with reference to FIGS. 22A to 22C. Note that descriptions of elements related to the third embodiment, which are substantially the same as those related to the first and second embodiments, are omitted so that remaining elements related to the third embodiment, which are different from the remaining elements related to the first and second embodiments, will be described.

FIG. 22A schematically illustrates a mobile antenna 201 according to a third embodiment of the present invention, which is mounted on the body frame B of the vehicle 3.

The mobile antenna 201 is provided with a linear antenna element 202 with one opening end 202b. The linear antenna element 202 is located at, for example, the upper-right corner portion 4b of the inner surface 4a of the front windshield 4.

The linear antenna element 202 is arranged along the center direction D of the corner angle θ formed by the front edge of the roof panel 5 and the windshield-side edge of the right front pillar 6. A feeding point (feeder) 14 is electrically connected to the other end 202a of the linear antenna element 202 such that power is fed to the antenna element 122 through the feeding point 14.

The overall length of the antenna element 202 is designed to

$$( \frac{λ}{4} ) \times the fractional shortening value within the range from 0.7 to 0.8 ;$$

this λ is a wavelength of target radio waves.

In the structure of the mobile antenna 201, when power fed to the antenna element 201 through the feeding point 14 allows an antenna current to flow through the antenna element 202 from the feeding point 14.

The antenna element 202 is arranged along the center direction D of the corner angle θ, so that it is inclined to the vertical and horizontal directions with respect to the ground surface.

This structure allows, as shown in FIGS. 2A and 2B, polarized surfaces C of the antenna element 202 to be non-orthogonal to each polarized surface A of each vertically polarized wave and each polarized surface B of each horizontally polarized wave in the radio waves, which is similar to the antenna element 2 according to the first embodiment.

Specifically, the mobile antenna 201 can effectively receive vertically and horizontally polarized waves when they are transmitted from the front side of the vehicle 3.

Furthermore, when vertically and horizontally polarized waves are transmitted from the rear side of the vehicle 3, the mobile antenna 201 permits the transmitted vertically polarized waves, which are diffracted by the roof panel 5 to enter into the interior of the vehicle 3, to be effectively received by the antenna element 202. This is because the antenna element 202 is arranged close to the roof panel 5 of the vehicle and each polarized surface C of antenna element 202 is not to be orthogonal but to be crossed, at approximately 45 degrees, to each of the polarized surfaces A of he vertically polarized waves.

In addition, the mobile antenna 201 permits the transmitted horizontally polarized waves, which are diffracted by the right-side of the vehicle to enter into the interior thereof, to be effectively received by the antenna element 202. This is because the antenna element 202 is arranged close to the right-side of the vehicle and each polarized surface of the antenna element 202 is not to be orthogonal but to be crossed, at approximately 45 degrees, to each of the polarized surfaces B of the horizontally polarized waves.

That is, it is possible for the mobile antenna 201 according to the third embodiment to effectively receive both the vertically polarized waves and the horizontally polarized waves transmitted from both the front side of the vehicle and the rear side thereof.

As described above, the mobile antenna 201 allows radio waves to be stably received independently of any direction of the vehicle's travel and/or any direction from which the radio waves are transmitted.

In addition, because the overall length of the antenna element 202 is set to approximately

$$( \frac{λ}{4} ) \times the fractional shortening value within the range from 0.7 to 0.8 .$$

This allows loss caused by the impedance matching in the antenna element 202 to decrease, making it possible to further improve the reception performance of the mobile antenna 201.

A modification of the mobile antenna 201 according to the third embodiment is illustrated in FIG. 22B. As shown in FIG. 22B, a mobile antenna 211 is provided with an antenna element 212 having a linear antenna element portion 202 with one opening end 202b.

In addition, the antenna element 212 is provided with loop members 214, 216, 217, and 218. The loop member 214 is arranged to be parallel to the front edge of the roof panel 5, one end of which is joined to an intermediate portion of the linear antenna element portion 202. The other end of the loop member 214 is joined to one end of the loop member 217, and the other end thereof extends onto the front edge of the roof panel 5 to be electrically connected to a ground point 213. The ground point 213 is mounted on the inner surface of the front edge of the roof panel 5 so as to be grounded thereto.

Moreover, the loop member 216 is arranged to be parallel to the windshield-side edge of the right front pillar 6, one end of which is joined to an intermediate portion of the linear antenna element portion 202. The other end of the loop member 216 is joined to one end of the loop member 218, and the other end thereof extends onto the windshield-side edge of the right front pillar 6 to be electrically connected to a ground point 215. The ground point 215 is mounted on the inner surface of the windshield-side edge of the right front pillar 6.

Specifically, the antenna element 212 has a short-circuit configuration.

A modification of the mobile antenna 201 according to the third embodiment is illustrated in FIG. 22C. As shown in FIG. 22C, a mobile antenna 221 is provided with an antenna element 222 having a linear antenna element portion 202 with one opening end 202b.

The antenna element 222 is provided with loop members 224, 226, 227, and 228. The configurations of the loop members 224 and 226 are substantially the same as those of the loop members 214 and 216.

The one end of the loop member 227 extends parallel to the antenna element portion 202, and the one end of the loop member 228 extends parallel to the antenna element portion 202.

Specifically, the antenna element 222 has an open-circuit configuration.

In the first embodiment of the present invention, the inner element portion 7, the connection element portion 10, the outer element portion 8, the connection element portion 11, and the outer element portion 9 provide two current paths (loops), but the present invention is not limited to the structure. Specifically, an antenna element of a mobile antenna can be configured to provide three or more current loops.

At least two of a plurality of the mobile antennas according to the second and third embodiments and their modifications can be mounted on the body frame B such that they are substantially symmetrically arranged in the space of the body frame B. This structure provides space diversity that can achieve space diversity effect. Moreover, at least two of a plurality of the mobile antennas according to the second and third embodiments and their modifications can be mounted on the body frame B such that directions in which antenna current components flow through the at least two antennas are different from each other. This structure can provide different polarized surfaces, making it possible to achieve polarization-diversity effect.

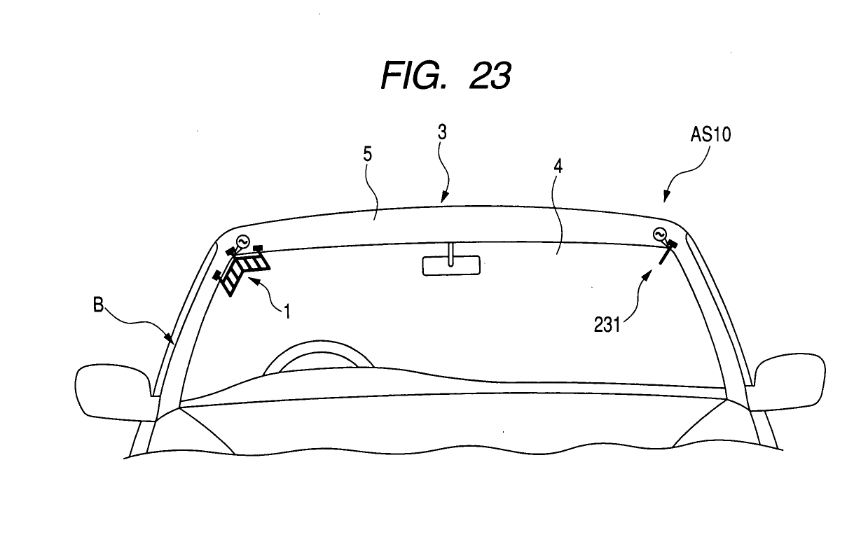

Furthermore, as illustrated in FIG. 23, an antenna system AS10 can be mounted on the body frame B of the vehicle 3. The antenna system AS10 is provided with the mobile antenna 1 according to the first embodiment, which is mounted at the upper-right corner portion 4b of the inner surface 4a of the front windshield 4.

In addition, the antenna system AS10 is provided with the mobile antenna 231 symmetrically placed in the vehicle 3 with respect to the mobile antenna 1 in the horizontal (lateral) direction of the vehicle 3.

Moreover, as illustrated in FIG. 14C, an antenna element 82 of a mobile antenna 81 can be provided with wide connection bars in place of the connection element portions 66 and 67.

Each of the wide connection bars has a width wider than that of each of the inner element portion 63 and the outer element portions 64 and 65.

The inner element portion 63, the outer element portions 64 and 65, and the wide connection bars can provide a plurality of current paths whose path lengths are different from each other.

In the third embodiment, the linear antenna element 202 has a wide width portion whose width is wider than that of the remaining portion of the linear antenna element 202 (see FIG. 20C).

In the third embodiment and its modifications, the linear antenna element (portion) 202 can extend in a curved line along the center direction D of the corner angle θ.

While there has been described what is at present considered to be these embodiments and modifications of the present invention, it will be understood that various modifications which are not described yet may be made therein, and it is intended to cover in the appended claims all such modifications as fall within the true spirit and scope of the invention.

1. A mobile antenna mounted on an electrically conductive body of a vehicle, in which the body of the vehicle has a roof portion, a pillar portion, and a corner portion at which the roof portion and the pillar portion meet, the roof portion, the pillar portion, and the corner portion supporting at least corner portion of a window of the vehicle, the mobile antenna comprising:
an electrically conductive antenna element having a first portion with one end and the other end extending therefrom, the one end of the first portion being arranged at least adjacent to any one of the roof portion, the pillar portion, and the corner portion and being electrically connected to a feeding point, the other end of the first portion being arranged along a surface of the window such that polarized surfaces formed by the antenna element are non-orthogonal to each polarized surface of each of a vertically polarized wave and a horizontally polarized wave in radio waves.

2. A mobile antenna according to claim 1, wherein a corner angle of the corner portion is formed by a window-side edge of the center portion and a window-side edge of the pillar portion, and the first portion of the antenna element is arranged in parallel to a center direction of the corner angle.

3. A mobile antenna according to claim 1, wherein the antenna element has a second portion with one end joined to the first portion to form a first loop, and the other end of the second portion is grounded to any one of the roof portion, the pillar portion, and the corner portion.

4. A mobile antenna according to claim 3, wherein the antenna element has a third portion with one end joined to the first portion to form a second loop, the other end of the third portion is grounded to another one of the roof portion, the pillar portion, and the corner portion.

5. A mobile antenna according to claim 3, wherein the antenna element has a plural-path forming portion configured to allow the first portion, the second portion, and the plural-path forming portion to form a plurality of current paths.

6. A mobile antenna according to claim 5, wherein the plural-path forming portion has any one of:
a mesh structure composed of a plurality of loops, the loops being contained in the current paths; and
a bypass structure joined between the first portion and the second portion.

7. A mobile antenna according to claim 5, wherein the second portion has a connection bar such that the one end of the second portion is joined to the first portion through the connection bar, and the connection bar has a width wider than that of each of the first portion and the second portion, the connection bar allowing the current paths to be formed therethrough.

8. A mobile antenna according to claim 1, wherein the window is made of glass, and an overall length of the antenna element is set to a length obtained by multiplying
$$( \frac{1}{2} λ0 )$$
by a fractional shortening value of the glass, the λ0 representing a wavelength corresponding to the lowest frequency within a target frequency range corresponding to the radio waves.

9. A mobile antenna according to claim 3, wherein a first angle formed by the second portion and a window-side edge of any one of the of the roof portion, the pillar portion, and the corner portion to which the other end is grounded is set to any one of a right angle and an obtuse angle so that capacity coupling occurs between the second portion and the window-side edge of any one of the of the roof portion, the pillar portion, and the corner portion.

10. A mobile antenna according to claim 3, wherein a second angle formed by the first portion and the second portion is set to an acute angle so that capacity coupling occurs between the first and second portions.

11. A mobile antenna according to claim 1, wherein the other end of the first portion extends from the one end thereof in any one of a line and a curve.

12. A mobile antenna according to claim 11, wherein the antenna element has a loop portion with one end and the other end, the one end of the loop portion being joined to the first portion, the other end of the loop portion being grounded to any one of the roof portion, the pillar portion, and the corner portion.

13. A mobile antenna according to claim 11, wherein the first portion has a wide width portion whose width is wider than that of the remaining portion thereof.

14. A mobile antenna according to claim 11, wherein the window is made of glass, and an overall length of the first portion is set to a length obtained by multiplying
$$( \frac{1}{4} λ0 )$$
by a fractional shortening value of the glass, the λ0 representing a wavelength corresponding to the lowest frequency within a target frequency range corresponding to the radio waves.

15. A mobile antenna system mounted on an electrically conductive body of a vehicle, in which the body of the vehicle has a roof portion, a pillar portion, and a corner portion at which the roof portion and the pillar portion meet, the roof portion, the pillar portion, and the corner portion supporting at least corner portion of a first window of the vehicle, and the roof portion supporting a second window of the vehicle, the mobile antenna system comprising:
a first mobile antenna comprising:
a first electrically conductive antenna element having a first portion with one end and the other end extending therefrom, the one end of the first portion being arranged at least adjacent to any one of the roof portion, the pillar portion, and the corner portion and being electrically connected to a first feeding point, the other end of the first portion being arranged along a surface of the first window such that polarized surfaces formed by the first antenna element are non-orthogonal to each polarized surface of each of a vertically polarized wave and a horizontally polarized wave in radio waves; and
a second mobile antenna comprising:
a second electrically conductive antenna element having a second portion with one end and the other end extending therefrom, the one end of the second portion being arranged at the body of the vehicle and being electrically connected to a second feeding point, the other end of the second portion being arranged along a surface of any one of the first window and the second window such that polarized surfaces formed by the second antenna element are non-orthogonal to each polarized surface of each of the vertically polarized wave and the horizontally polarized wave in the radio waves, the second mobile antenna being substantially symmetrically placed in the body of the vehicle.

16. A mobile antenna system according to claim 15, wherein, when first current is fed to the first antenna element through the first feeding point and second current is fed to the second antenna element through the second feeding point, the second mobile antenna is arranged in the vehicle such that a direction of the first current flowing through the first antenna element is different from that of the second current flowing through the second antenna element.

17. An electrically conductive body of a vehicle, the body comprising:
a roof portion;
a pillar portion;
a corner portion at which the roof portion and the pillar portion meet, the roof portion, the pillar portion, and the corner portion supporting at least corner portion of a window of the vehicle; and
a mobile antenna provided with an electrically conductive antenna element having a first portion with one end and the other end extending therefrom, the one end of the first portion being arranged at least adjacent to any one of the roof portion, the pillar portion, and the corner portion and being electrically connected to a feeding point, the other end of the first portion being arranged along a surface of the window such that polarized surfaces formed by the antenna element are non-orthogonal to each polarized surface of each of a vertically polarized wave and a horizontally polarized wave in radio waves.
